(19) United States
(12) Patent Application Publication
(10) Pub. No.: US 2009/0003742 A1
(43) Pub. Date: Jan. 1, 2009

(54) Grease Composition For Hub Unit Bearing, And Hub Unit Bearing For Vehicle

(75) Inventors: Shinya Nakatani, Kanagawa (JP); Jun Kuraishi, Kanagawa (JP); Tomoaki Matsumoto, Kanagawa (JP); Minoru Namiki, Kanagawa (JP); Ryo Aida, Kanagawa (JP); Toshiaki Endo, Kanagawa (JP)

Correspondence Address: SUGHRUE-265550, 2100 PENNSYLVANIA AVE. NW, WASHINGTON, DC, 20037-3213, US

(73) Assignees: NSK LTD., Tokyo (JP); KYODO YUSHI CO., LTD., Tokyo (JP)

(21) Appl. No.: 11/814,624

(22) PCT Filed: Jan. 24, 2006
(86) PCT No.: PCT/JP2006/301047

§ 371 Date: Jul. 24, 2007

(30) Foreign Application Priority Data
Jan. 24, 2005 (JP) 2005-015469
Jul. 12, 2005 (JP) 2005-203328
Jul. 12, 2005 (JP) 2005-203329
Jul. 25, 2005 (JP) 2005-214053

(51) Int. Cl. F16C 31/04; C10M 169/04

(52) U.S. Cl. 384/289; 508/100; 508/110; 508/552; 508/500; 508/562; 508/583; 508/280; 508/443; 508/390; 508/577

(57) ABSTRACT

An object of the invention is to provide a grease composition capable of keeping a good lubrication condition for a long period of time even when water has mixed therein, thereby inhibiting white structure flaking and corrosion. Another object is to provide a vehicular hub unit bearing which hardly suffers from white structure flaking and corrosion even when used in an environment where water may penetrate into it and which therefore has a long life.

The invention provides a rolling bearing with, sealed up therein, a grease composition containing a waterproof film-forming additive added thereto; a grease composition for hub unit bearings, containing a base oil that comprises at least one of mineral oil and synthetic oil as the main ingredient thereof, and a thickener and a flaking inhibitor; and a vehicular hub unit bearing with the grease composition sealed up therein.

### TECHNICAL FIELD

The present invention relates to a grease composition having excellent flaking resistance and capable of maintaining good lubrication for a long period of time, and to a vehicular hub unit bearing.

### BACKGROUND ART

A so-called hub unit bearing of a closed type provided with a seal has heretofore been much used as a bearing for vehicles such as motorcars, railroad cars, etc. The vehicular hub unit bearing is used, generally while exposed to outdoor water and dust. In addition, it may be used while buried in muddy water. The vehicular hub unit bearing that is used in such an atmosphere is sealed up with a sealing unit and is therefore protected from penetration of external water and dust thereinto; however, it is difficult to completely protect it from water penetration thereinto. Accordingly, the grease composition filled in the vehicular hub unit bearing may be in contact with water; but it is generally known that when water is mixed in the grease composition, then it greatly shorten the durability life of rolling bearings. For example, Furumura et al. report that, when 6% water is mixed in a lubricant oil (#180 turbine oil), then a rolling fatigue life lowers to from one-severalth to 1/20 of that in a case with no water mixing (see Non-Patent Reference 1). Schatzberg et al. report that, when only 100 ppm water is mixed in lubricant oil, then its steel rolling strength lowers by from 32 to 48% (see Non-Patent Reference 2).

The shortening of life may be considered because the hydrogen generated through decomposition of the mixed water may penetrate into the steel of a bearing material to cause hydrogen embrittlement, thereby resulting in metal flaking accompanied by a change into a white structure owing to the hydrogen embrittlement (hereinafter this may be referred to as white structure flaking). For preventing such white structure flaking, grease compositions with various additives added thereto have been proposed.

For example, proposed are a grease composition with a passivate oxidizing agent such as sodium nitrite added thereto (see Patent Reference 1); a grease composition with an organic antimony compound or an organic molybdenum compound added thereto (see Patent References 2 and 3); and a grease composition with an inorganic compound having a particle size of at most 2 μm added thereto (see Patent Reference 4). These grease compositions form the additive-derived coating film around the rolling contact part (raceway surface, rolling surface) of a rolling bearing to thereby prevent hydrogen from penetrating into the bearing material.

As a grease capable of preventing a vehicular hub unit bearing from flaking even when it contains water, there is known a waterproof grease prepared by adding a surfactant having HLB of from 3 to 14 to a grease containing a diurea compound serving as a thickener (for example, Patent Reference 5). In addition, also known is a waterproof grease containing a base oil, a thickener and an N-vinylamide resin (for example Patent Reference 6).

On the other hand, known is a grease composition for wheel-supporting bearings, to which is added ZnDTP for improving the abrasion resistance of the bearings (see Patent Reference 7).

In addition, when water is mixed in a grease, then the shearing stability of the grease may lower and the grease may flow out though a lubricated site. As a grease of which the shearing stability is improved even when it contains water, proposed are a grease with a metal phenate added thereto (see Patent Reference 8); and a grease with a calcium or magnesium salt of a fatty acid added thereto (see Patent Reference 9).

Apart from grease compositions, also proposed are a method of using stainless steel as a bearing material (see Patent Reference 10, and a method of using a ceramic rolling element (see Patent Reference 11),
Patent Reference 1: Japanese Patent Examined Publication JP-B-2878749
Patent Reference 2: Japanese Patent Unexamined Publication JP-A-6-203565
Patent Reference 3: Japanese Patent Examined Publication JP-B-3512183
Patent Reference 4: Japanese Patent Unexamined Publication JP-A-9-169989
Patent Reference 5: Japanese Patent Unexamined Publication JP-A-9-87652
Patent Reference 6: Japanese Patent Unexamined Publication JP-A-2005-105026
Patent Reference 7: Japanese Patent Unexamined Publication JP-A-2001-254089
Patent Reference 8: Japanese Patent Examined Publication JP-B-2-8639
Patent Reference 9: Japanese Patent Examined Publication JP-B-3-26717
Patent Reference 10: Japanese Patent Unexamined Publication JP-B-3-173747
Patent Reference 11: Japanese Patent Unexamined Publication JP-B-4-244624
Non-Patent Reference 1:
   Kyozaburo Furumura, Shinichi Shirota, Kiyoshi Hirakawa, Regarding rolling fatigue at surface starting point and inner starting point, NSK Bearing Journal, No. 636, pp. 1-10, 1977
Non-Patent Reference 2;
   P. Schatzberg, I. M. Felsen: Effects of water and oxygen during rolling contact lubrication, Wear, 12, pp. 331-342, 1968

### DISCLOSURE OF THE INVENTION

### Problems that the Invention is to Solve

However, the grease compositions described in the above-mentioned Patent References 1 to 4, which contain various additive added thereto, may have a trouble of flaking in rolling contact parts when water is mixed in them or rolling elements are slid owing to their vibration or speed change before the additives in them may act to form sufficient coating films.

The flaking preventing effect of the waterproof greases described in Patent References 5 and 6 could not be satisfactory for the recent requirement for prolongation of the life of bearings. In motorcars and others, the driving vibration in long-distance tracking or transport by rail may be transmitted to bearings, and therefore there may occur fretting wear caused by repeated shock between rolling elements and inner and outer raceways; however, conventional mineral oil-lithium soap type grease could not be satisfactory for the recent requirement for high durability, in point of the durability thereof to such fretting wear (fretting resistance). Lubricant grease applicable to high-temperature/high-load driving is desired, for which the demand may increase in future.

The grease composition described in Patent Reference 7 may have improved abrasion resistance, as containing an extreme-pressure agent such as ZnDTP added thereto; but when water is mixed therein, it could not be satisfactory for preventing shortening of the life before flaking.

The greases that have improved shearing stability when containing water, as in Patent References 8 and 9, are water-repellent greases, in which, therefore, water kept in contact with the grease may form large water droplets and may be taken in the grease to exist heterogeneously therein. As a result, they have a problem in that the oily film formed on the slide face of the lubricated site may be partially removed, and their lubrication capability may lower starting from that part.

The rolling bearings described in Patent References 10 and 11, in which stainless steel or ceramics are used as the bearing material, have a problem in that they are expensive.

In addition, iron such as bearing steel may be readily corroded (rusted) when water exists around it, and therefore has a problem in that the rolling bearings may make noises though raceway surfaces or rolling element surfaces may not be flaked. Regarding vehicular hub unit bearing that may be wetted with water, it is extremely important that they are resistant to corrosion, and therefore, some measures are taken for them according to the same methods as above; but at present, the corrosion-preventing effect could not also be satisfactory for the recent requirement for bearings of high reliability.

Accordingly, an object of the present invention is to solve the prior-art problems mentioned above, and to provide a grease composition which may keep a good lubrication condition for a long period of time even when water is mixed therein and which may prevent white structure flaking or corrosion or both white structure flaking and corrosion. Another object of the invention is to provide a long-life vehicular hub unit bearing, which hardly undergoes white structure flaking or corrosion even when used in an environment in which water may penetrate into it.

### Means for Solving the Problems

(1) A rolling bearing with, sealed up therein, a grease composition containing a waterproof film-forming additive added thereto.

(2) A grease composition for hub unit bearings, containing a base oil that contains at least one of mineral oil and synthetic oil as the main ingredient thereof, and a thickener and a flaking inhibitor.

(3) The grease composition for the hub unit bearings of above (2), wherein the thickener is at least one of metal soap, metal complex soap and urea compounds, the flaking inhibitor is a passivating agent, and the content of the passivating agent is from 0.1 to 5 wt %.

(4) The grease composition for hub unit bearings of above (2), wherein the flaking inhibitor is oleoyl sarcosine, and its content is from 0.1 to 5 wt %.

(5) The grease composition for hub unit bearings of above (2), wherein the flaking inhibitor is poly(oxyethylene) dodecylamine, and its content is from 0.1 to 3 wt %.

(6) The grease composition for hub unit bearings of above (2), wherein the flaking inhibitor is bismuth 2-ethylhexylate, and its content is from 0.1 to 5 wt %.

(7) The grease composition for hub unit bearings of above (2), wherein the base oil is a mineral oil, the thickener is an aromatic urea, and the flaking inhibitor is calcium sulfonate, zinc dithiocarbamate, benzotriazole or its derivative.

(8) The grease composition for hub unit bearings of above (2), wherein the thickener is a metal composite soap or an urea compound, and the flaking inhibitor is a surfactant and a metal inactivator.

(9) The grease composition for hub unit bearings of above (2), wherein the flaking inhibitor is an amine-type rust inhibitor containing a salt of oleic acid and dicyclohexylamine, and its content is from 0.1 to 5 wt %.

(10) The grease composition for hub unit bearings of above (2), wherein the flaking inhibitor is a carboxylic acid anhydride, and its content is from 0.1 to 5 wt %.

(11) A vehicular hub unit bearing, containing an outer peripheral side member having a raceway surface in the inner peripheral surface thereof, an inner peripheral side member having a raceway surface in the outer peripheral surface thereof, plural rolling elements rollably disposed between the raceway surface of the outer peripheral side member and the raceway surface of the inner peripheral side member, and a cage rollably holding the plural rolling elements, wherein a space, which is formed between the inner peripheral side member and the outer peripheral side member and has the rolling elements disposed therein, is sealed up with the grease composition of any of above (1) to (10).

### EFFECT OF THE INVENTION

The grease composition for hub unit bearings of the invention has excellent flaking resistance, waterproof ness and corrosion resistance, and even when used in an environment in which water may penetrate into it or in the presence of water around it, it hardly undergoes white structure flaking or corrosion. Accordingly, the composition may keep good lubrication for a long period of time.

### BRIEF DESCRIPTION OF THE DRAWINGS

FIG. 1 is a vertical cross-sectional view showing the structure of a vehicular hub unit bearing of the invention;

FIG. 2 is a vertical cross-sectional view showing the structure of another vehicular hub unit bearing of the invention;

FIG. 3 is a view showing a hearing for use in a vehicular hub unit bearing of the invention;

FIG. 4 is a picture, taken with a camera, of a condition of water in a grease of Example F1 in wet Shell Roll Test;

FIG. 5 is a picture, taken with a camera, of a condition of water in a grease of Example F2 in wet Shell Roll Test;

FIG. 6 is a picture, taken with a camera, of a condition of water in a grease of Example F3 in wet Shell Roll Test;

FIG. 7 is a picture, taken with a camera, of a condition of water in a grease of Example F4 in wet Shell Roll Test; and

FIG. 8 is a picture, taken with a camera, of a condition of water in a grease of Comparative Example F1 in wet Shell Roll Test.

### DESCRIPTION OF REFERENCE NUMERALS

1 vehicular hub unit bearing
2 hub
3 inner ring
4 outer ring
5 rolling element
6 wheel attachment flange
8 step
8a step face
10 cylinder
11 nut
12 sealing unit
13 closed space
14 cover
16 cage
17 wheel attachment flange
20a, 20b inner raceway surface
21a, 21b outer raceway surface
7 vehicular hub unit bearing
73 wheel attachment flange
74 inner ring
75 hub
76 rolling element
77 cage
78 seal member
91 inner ring
92 outer ring
93 rolling element
94 cage
95 seal member

### BEST MODE FOR CARRYING OUT THE INVENTION

Embodiments of the invention are described with reference to the drawings.

### <Regarding Vehicular Hub Unit Bearing>

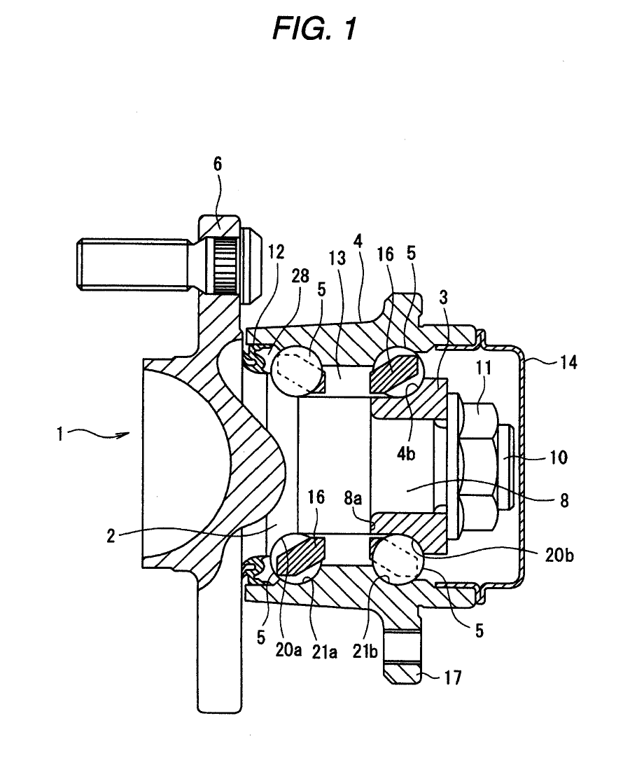

FIG. 1 is a view showing a vehicular hub unit bearing of this embodiment. In the following description, the vehicular hub unit bearing is fitted to a vehicle such as a motorcar, and in that condition, the outer side in the width direction of the vehicle is referred to as an outer end side, and the center side in the width direction thereof is referred to as an inner end side. Accordingly, in FIG. 1, the left side is the outer end side, and the right side is the inner end side.

The vehicular hub unit bearing 1 of FIG. 1 has the hub 2, the inner ring 3, the outer ring 4, and the rolling elements 5, 5 in double rows, and is provided with the wheel attachment flange 6, which is for attaching it to a wheel (not shown), at the outer end side part of the outer peripheral surface of the hub 2. The inner end side of the hub 2 is formed to have a small-diameter part 8 having a smaller outer diameter, and the inner ring 3 is fitted into the small-diameter part 8. In addition, the part on the inner end side than the small-diameter part 3 of the hub 2 is formed to have a protruding cylinder 10, and a male screw is formed on the outer peripheral surface ca the cylinder 10. The inner ring 3 is held sandwiched between the nut 11 screwed into the male screw, and the step face 8a formed in the boundary between the small-diameter part 8 and a part having a larger outer diameter on the outer end side than the small-diameter part 8, whereby the inner ring 3 is integrally fixed to the hub 2. The inner ring 3 and the hub 2 constitute the inner peripheral side member of the invention; and the outer ring 4 constitutes the outer peripheral side member of the invention.

On the outer peripheral surface of the inner ring 3 and on the outer peripheral surface of the hub 2 positioning on the outer side than the inner ring 2, formed are the inner raceway surfaces 20a, 20b. On the inner peripheral surface of the outer ring 4, formed are the outer raceway surfaces 21a, 21h corresponding to the inner raceway surfaces 20a, 20b, respectively. Further, plural rolling elements 5, 5 are rollably disposed between the inner raceway surfaces 20a, 20b and the outer raceway surfaces 21a, 21b; and the inner peripheral side member is thereby made rotatable relative to the outer ring 4. In a unit bearing for relatively lightweight vehicles such as passenger cars, a ball is often used for the rolling element 5. But in a unit bearing for heavyweight vehicles, a roller is often used for it. For example, in a unit bearing for large-size motorcars, a tapered roller is often used; and in a unit bearing for railroad cars, a tapered roller or a cylindrical roller is often used.

A sealing unit 12 is disposed between the inner peripheral surface of the outer peripheral side part of the outer ring 4 and the outer peripheral surface of the hub 2 facing to it; and this seals up the end opening of the bearing space formed between the inner peripheral side member and the outer ring 4. In the bearing space, disposed are crown-shaped cages 16, 16 formed of a synthetic resin, which hold the rolling elements 5, 5 aligned in double rows in such a manner that the openings of the pockets could face in the opposite directions to each other; and the part sandwiched between the pair of the cages 16, 16 forms the closed space 13 in the bearing space. The closed space 13 is, though not shown, filled with a grease composition (this is described in detail hereinunder) that lubricates the rolling elements 5, 5, the outer raceway surfaces 21a, 21b, and the inner raceway surfaces 20a, 20b. The grease composition filled in the closed space 13 is partly stirred by the rolling elements 5, 5, and the remaining major part thereof is not stirred; and therefore, the grease composition is, as a whole, degraded little, and it may keep its quality for a long period of time. Further, the opening part on the inner peripheral side of the bearing space is sealed up with the cover 14 provided on the inner peripheral side of the outer ring 4, and the cover 14 acts to prevent impurities such as water and dust from penetrating into the bearing space and to prevent the grease composition in the bearing space from leaking out.

On the outer peripheral surface of the outer ring 4, disposed is a suspension attachment flange 17, at the end on the side spaced from the wheel attachment flange 6. For attaching the vehicular hub unit bearing 1 to a motorcar, the outer ring 4 is fixed to a suspension (not shown) via the suspension attachment flange 17, as formed on the outer peripheral surface of the outer ring 4, and the wheel is fixed to the wheel attachment flange 6. As a result, the wheel is supported by the vehicular hub unit bearing 1, rotatably to the suspension.

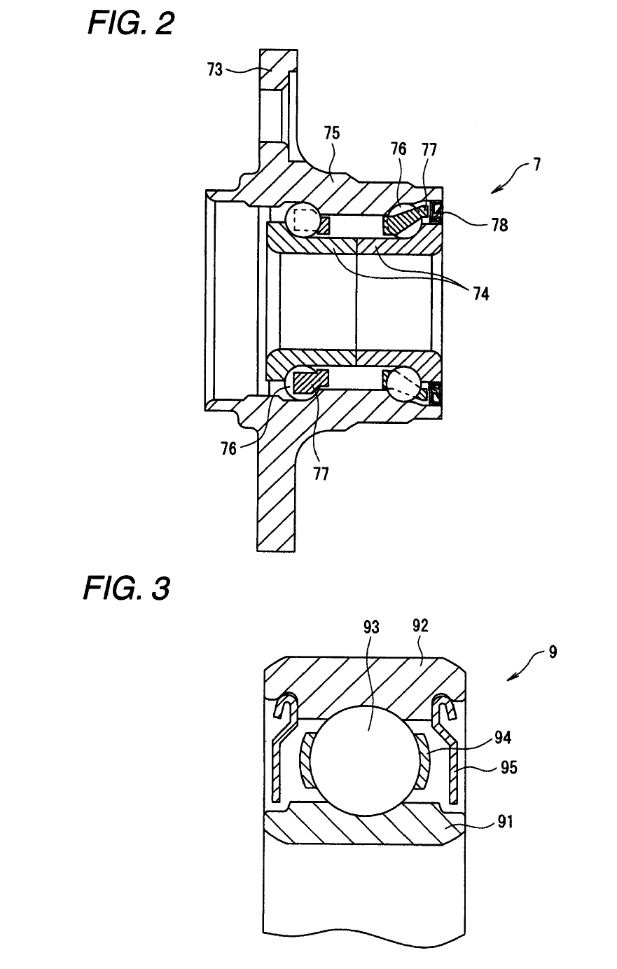

For its application, the present invention is not limited to the vehicular hub unit bearing 1, in which a part of the inner peripheral side member is integrated with the hub as mentioned hereinabove. For example, the invention is applicable to a vehicular hub unit bearing, in which the outer peripheral side member is integrated with the hub, as in FIG. 2; or to a supporting bearing 9 for vehicles that is fitted to a separate hub as in FIG. 13.

The vehicular hub unit bearing 7 of FIG. 2 has an outer peripheral side member of the invention that constitutes a part of the hub 75, two inner rings 74, 74 that constitutes the inner peripheral aide member of the invention, rolling members 76, 76 in double rows, and a cage 77. Also in FIG. 2, the left side is the outer end side and the right side is the inner end side, like in FIG. 1. At the outer peripheral side part of the outer peripheral surface of the hub 75, disposed is a wheel attachment flange 73, which is for attaching a wheel (not shown) to the unit; and on the inner periphery of the inner peripheral side part of the hub 75 that is cylindrical, formed are outer raceway surfaces in double rows. On the outer peripheries of the two inner rings 74, 74, formed are inner raceway surfaces that correspond to the above outer raceway surfaces; and between these outer raceway surfaces and the inner raceway surfaces, rollably disposed are plural rolling elements 76 so that the hub 75 is made rotatable relative to the inner rings 74, 74. The inner rings 74, 74 are fitted to a shaft (not shown), and the shaft is supported by a vehicle body and the wheel attached to the hub 75 is thereby supported by the vehicle body rotatably thereto.

A grease composition of the invention is filled in the bearing space between the hub 75 and the inner rings 74, 74 of the vehicular hub unit bearing 7; and the bearing space is sealed up with the seal member 78 disposed in the inner peripheral side part of the bearing space and a cover (not shown) disposed at the outer peripheral side part of the hub 75. In that manner, since the vehicular hub unit bearing 7 is filled with a grease composition of the invention, it has excellent flaking resistance.

The wheel-supporting bearing 9 of FIG. 3 is a rolling bearing having an inner ring 91 to constitute the inner peripheral side member of the invention, an outer ring 92 to constitute the cuter peripheral side member of the invention, rolling elements 93, a cage 94 and a seal member 95. The space between the inner ring 91 and the outer ring 92 is filled with a grease composition of the invention, and therefore the wheel-supporting bearing 9 has excellent flaking resistance.

The grease composition for hub unit bearing of the invention (hereinafter this may be simply referred to as grease composition) is described in detail hereinunder, showing some concrete embodiments thereof.

### FIRST EMBODIMENT

### Grease Composition Example A

The grease composition of the invention has a flaking inhibitor, a base oil and a thickener.

The flaking inhibitor is preferably a passivating agent, which is a compound capable of forming a passivated film on at least one of the above-mentioned inner raceway surfaces 20a, 20b, and the above-mentioned outer raceway surfaces 21a, 21b formed of various types of steel that may contain any other metal element. The passivated film is formed not only as an oxide film to be formed generally as a passivated film but also as a tough coating film through covalent bonding between the metal to constitute the raceway surface and the compound from the passivating agent. For the passivating agent, for example, usable are inorganic corrosion inhibitors such as nitrites, nitrates, chromates, phosphates, molybdates, tungstates; and metal inactivators such as benzotriazole. The passivating agent may from a passivated film on a metal surface, thereby improving the flaking resistance of the metal. In addition, the passivated film may inhibit the contact of water having mixed in the grease composition, with metal, thereby preventing metal corrosion; and it may inhibit the metal component to form the raceway surface from being released out, thereby exhibiting its flaking-resistant effect even under a wetted condition. The amount of the passivating agent is from 0.1 wt % to 5 wt % of the overall amount of the grease composition. Preferably, a triazole compound such as benzotriazole or toluyltriazole may be used as the passivating agent, and its more preferred amount to be added may be from 1 to 3 wt %. When the amount is less than 0.1 wt %, then the composition could not exhibit the antiflaking effect; but when more than 5 wt %, then the effect may be saturated and it is uneconomical.

The grease composition to be filled in the closed space 13 in the vehicular hub unit bearing 1 of the above-mentioned embodiment contains a passivating agent in an amount or from 0.1 wt % to 5 wt %, and therefore, a passivated film may be formed on at least one of the above-mentioned inner raceway surfaces 20a, 20b, and the above-mentioned outer raceway surfaces 21a, 21b formed of steel. Accordingly, even when vehicles run in an environment in which water may penetrate into the vehicles, the passivated film may inhibit direct contact between water and metal, and therefore, the vehicular hub unit bearing 1 may have excellent flaking resistance on the raceway surfaces and may have a long life.

The base oil has at least one of mineral oil and synthetic oil, preferably in an amount of at least 50 wt % of the overall amount of the base oil, more preferably at least 80 wt %.

The mineral oil includes paraffinic mineral oil, naphthenic mineral oil and their mixed oil; and preferred are those purified through one or more steps of reduced-pressure distillation, oil deasphalting, solvent extraction, hydro-cracking, solvent dewaxing, sulfuric acid washing, white clay purification and hydro-refining, either singly or as combined.

The synthetic oil includes hydrocarbon oils, aromatic oils, eater oils, ether oils. The hydrocarbon oils include normal paraffin, isoparaffin, polybutene, polyisobutylene, 1-decene oligomer, poly-α-olefin (co-oligomer of 1-decene and ethylene) and their hydrates. The aromatic oils include alkylbenzenes (e.g., monoalkylbenzenes, dialkylbenzenes), alkylnaphthalenes (e.g., monoalkylnaphthalenes, dialkylnaphthalenes, polyalkylnaphthalenes). The ester oils include diester oils (e.g., dibutyl sebacate, di(2-ethylhexyl) sebacate, dioctyl adipate, diisodecyl adipate, ditridecyl adipate, ditridecyl glutarate, methyl acetylcinnolate), aromatic ester oils (e.g., trioctyl trimellitate, tridecyl trimellitate, tetraoctyl pyromellitate), polyol ester oils (e.g., trimethylolpropane caprylate, trimethylolpropane pelargonate, pentaerythritol 2-ethylhexanoate, pentaerythritol pelargonate), and complex ester oils that are oligoesters of a mixed fatty acid of a dibasic acid and a monobasic acid with a polyalcohol. The ether oils include polyglycols (e.g., polyethylene glycol, polypropylene glycol, polyethylene glycol monoether polypropylene glycol monoether), phenyl ether oils (e.g., monoalkyltriphenyl ether, alkyldiphenyl ether, dialkyldiphenyl ether, pentaphenyl ethers tetraphenyl ether, monoalkyltetraphenyl ether, dialkyltetraphenyl ether). One or more these synthetic oils may be used herein either singly or as combined.

The kinematic viscosity of the base oil at 40° C. is preferably from 40 mm²/sec to 250 mm²/sec. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition, and when more than 250 mm²/sec, then the torque may increase and therefore it is unfavorable from the viewpoint of heat resistance.

The thickener is preferably at least one of metal composite soap and urea compounds, it is not specifically defined in point of its type, and any one generally used as a thickener in a grease composition may be usable herein. In consideration of the environment in which vehicles run, the thickener is preferably one not containing a heavy metal. For example, herein usable are metal soap or metal composite soap in which the metal component is any of lithium, calcium, aluminium, magnesium or sodium; urea compounds (e.g. diurea, triurea, tetraurea, polyurea), and inorganic compounds (e.g., bentonite, silica, carbon black). In particular, while the bearing is driven, its inside may be at a high temperature, and therefore, heat-resistant metal complex soap and urea compounds are preferred, and urea compounds are more preferred. One or more such thickeners may be used either singly or as combined.

Not specifically defined, the content of the thickener may be within a range within which the grease composition containing the above base oil and the thickener may exhibit its lubricating effect. Preferably, the content may be from 5 wt % to 35 wt % of the overall amount of the grease composition, more preferably from 5 wt % to 25 wt %, even more preferably from 8 wt % to 25 wt %. When less than 5 wt %, then the amount of the thickener is too small and the grease could hardly exhibit its mechanical properties. When more than 35 wt %, then the amount of the base oil shall be small, and the lubrication with the composition may be insufficient.

In addition to the above-mentioned ingredients, the grease composition may optionally contain various additives for further improving its various properties. For example, as an antioxidant, usable are amine compounds, phenol compounds, sulfur compounds, zinc dithiophosphate. As a rust inhibitor, usable are metal sulfonates, carboxylic acids, ester compounds, amine compounds. As an oil improver, usable are fatty acids, fatty acid esters. As an extreme pressure agent, usable are sulfur-type extreme pressure agents, phosphorus-type extreme pressure agents, metal dithiophosphates, metal dicarbamates. As a viscosity index improver, usable are polymethacrylates, polyisobutylenes, polystyrenes. One or more such additives may be used either singly or as combined. The overall content of the additives is preferably 20% or less by mass of the overall amount of the grease composition.

Since the unit bearing for vehicles and the wheel-supporting bearing are closed bearings, the mixture consistency of the grease composition is preferably controlled to be from 220 to 340, more preferably from 265 to 340. Within the range, the composition may readily form a waterproof coating film and an oxide coating film and may keep good lubrication. On the other hand, when the composition is softer than 340, then the grease may leak out; but when harder than 220, then the grease flowability may be poor and its lubrication may be therefore poor.

### SECOND EMBODIMENT

### Grease Composition Example B

### [Base Oil]

The base oil to be used contains at least one of mineral oil-type and synthetic oil-type lubricant oils. The mineral oil-type lubricant oil includes those prepared by purification of mineral oil through reduced-pressure distillation, oil deasphalting, solvent extraction, hydro-cracking, solvent dewaxing, sulfuric acid washing, white clay purification and hydro-refining, suitably as combined. The synthetic oil-type lubricant oil includes hydrocarbon oils, aromatic oils, ester oils, ether oils.

The hydrocarbon oils include poly-α-olefins or their hydrides such as normal paraffin, isoparaffin, polybutene, polyisobutylene, 1-decene oligomer, 1-decene/ethylene co-oligomer.

The aromatic oils include alkylbenzenes such as monoalkylbenzenes, dialkylbenzenes; and alkylnaphthalenes such as monoalkylnaphthalenes, dialkylnaphthalenes, polyalkylnaphthalenes.

The ester oils include diester oils such as dibutyl sebacate, di-2-ethylhexyl sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate; polyol ester oils such as trimethylolpropane caprylate, trimethylolpropane pelargonate, pentaerythritol 2-ethylhexanoate, pentaerythritol pelargonate; complex ester oils that are oligoesters of polyalcohol and mixed fatty acid of dibasic acid and monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, pentaphenyl ether, tetraphenyl ether, monoalkyltetraphenyl ether, dialkyltetraphenyl ether. Other synthetic lubricant base oils are tricresyl phosphate, silicone oil, perfluoroalkyl ether. One or more these base oils may be used herein either singly or as combined.

The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

### [Thickener]

Not specifically defined, the thickener may be any one having the ability to form a gel structure and to keep a base oil in the gel structure. For example, metal soaps, such as metal soap with any of Li and Na, composite metal soap with any of Li, Na, Ba and Ca; or non-soap such as Benton, silica gel, urea compounds, urea/urethane compounds, urethane compounds may be suitably selected and used. However, with the current rapid development of hub units, the inside of hub units may be at higher temperatures, and therefore in consideration of the heat resistance of grease, preferred are urea compounds, urea/urethane compounds, urethane compounds or their mixtures. The urea compounds include diurea compounds, triurea compounds, tetraurea compounds, polyurea compounds, urea/urethane compounds, diurethane compounds and their mixtures. Of those, preferred are diurea compounds, urea/urethane compounds, diurethane compounds or their mixtures. Even more preferably, a diurea compound is added to the composition. Preferably, the amount of the urea compound serving as a thickener is from 5 to 40 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but when the amount of the thickener is more than 40 wt %, then the grease composition may be too hard to fully exhibit its lubricating condition, and it is therefore unfavorable.

The consistency of the grease composition is preferably within a range of from 220 to 340, more preferably from 265 to 340. Within the range, the composition may readily form a waterproof coating film and an oxide coating film and may keep good lubrication. On the other hand, when it is smaller than 220, then the composition may be too hard and its lubricating effect could not be expected; but when larger than 340, then the composition may leak out from the inside of bearings.

### [Flaking Inhibitor]

Preferably, the grease composition of the invention contains oleoyl sarcosine as a flaking inhibitor. Its content may be from 0.1 to 5 wt % of the overall amount of grease, more preferably from 0.5 to 3 wt %. Further preferably, the content may be from 0.5 to 2 wt %. When the content is less than 0.1 wt %, then the inhibitor may be ineffective; but even though more than 5 wt %, its effect may not increase any more. When containing oleoyl sarcosine, the grease composition may have improved rustproofness, waterproofness and flaking resistance.

### [Other Additives]

Various additives may be optionally added to the grease composition of the invention for further improving its various properties. For example, one or more additives generally used in grease compositions, such as antioxidant, extreme pressure agent, oil improver, metal inactivator, may be used either singly or as combined. Not interfering with the object of the invention, any other rust inhibitor may be added to the composition.

The antioxidant includes, for example, amine compounds, phenol compounds, sulfur compounds, zinc dithiophosphate.

Examples of the amine-type antioxidant are p,p′-dioctyldiphenylamine, phenyl-1-naphthylamine, phenyl 2-naphthylamine, diphenylamine, phenylenediamine, oleylaidamine, phenothiazine.

Examples of the phenol-type antioxidant are hindered phenols such as p-t-butylphenyl salicylate, 2,6-di-t-butyl-p-phenylphenol, 2,2′-methylenebis(4-methyl-6-t-butylphenol), 4,4′-butylidenebis(6-t-butyl-m-cresol), tetrakis[methylene-3-(3′, 5′-di-t-butyl-4-hydroxyphenyl)propionate]methane, 1,3,5-trimethyl-2,4,6-tris(3,5-di-t-butyl-4-hydroxybenzyl) benzene, n-octadecyl β-4-hydroxy-3′, 5′-di-t-butylphenyl)propionate, 2-n-octyl-thio-4,6-di(4′-hydroxy-3′, 5′-di-t-butyl)phenoxy-1,3,5-triazine, 4,4′-thiobis(6-t-butyl-m-cresol), 2-(2-hydroxy-3′-t-butyl-5′-methylphenyl)-5-chlorobenzotriazole.

The oil improver includes, for example, fatty acids such as oleic acid, stearic acid; alcohols such as lauryl alcohol, oleyl alcohol; amines such as stearylamine, cetylamine; phosphates such as tricresyl phosphate; animal and vegetable oils.

In addition, an extreme pressure agent such as phosphorus compounds, zinc dithiophosphate, organic molybdenum compounds; and a metal inactivator such as benzotriazole may also be used.

The rust inhibitor includes, for example, esters. Examples of the esters are sorbitan esters such as sorbitan monolaurate, sorbitan tristearate, sorbitan monooleate and sorbitan trioleate that are partial esters of polybasic carboxylic acids with polyalcohols; and alkyl esters such as polyoxyethylene laurate, polyoxyethylene oleate, polyoxyethylene stearate.

Not specifically defined, the amount of the additive may be any one not interfering with the object of the invention; and in general, it may be from 0.1 to 20 wt % of the overall amount of the grease composition. It less than 0.1 wt %, then the additive may be poorly effective; and even if more than 20 wt %, the additive effect could not increase any more, but rather since the amount of the base oil may relatively decrease, the lubrication may be poor and it is therefore unfavorable.

### [Production Method]

The method for producing the grease composition of the invention is not specifically defined. In general, however, it may be obtained by reacting a thickener in a base oil. Preferably, a predetermined amount of a flaking inhibitor is added to the base grease obtained from the base oil and the thickener. However, after the flaking inhibitor is added thereto, the mixture must be fully stirred and uniformly dispersed, using a kneader or a roll mill. Heating may be effective in this treatment. In the above production method, it is desirable from the process thereof that additives such as abrasion inhibitor and antioxidant are added to the system simultaneously with the flaking inhibitor thereto.

### THIRD EMBODIMENT

### Grease Composition Example C

### [Base Oil]

The base oil to be used has at least one of mineral oil-type and synthetic oil-type lubricant oils. The mineral oil-type lubricant oil includes those prepared by purification of mineral oil through reduced-pressure distillation, oil deasphalting, solvent extraction, hydro-cracking, solvent dewaxing, sulfuric acid washing, white clay purification and hydro-refining, suitably as combined. The synthetic oil-type lubricant oil includes hydrocarbon oils, aromatic oils, ester oils, ether oils.

The hydrocarbon oils include poly-α-olefins or their hydrides such as normal paraffin, isoparaffin, polybutene, polyisobutylene, 1-decene oligomer, 1-decene and ethylene co-oligomer.

The aromatic oils include alkylbenzenes such as monoalkylbenzenes, dialkylbenzenes; and alkylnaphthalenes such as monoalkylnaphthalenes, dialkylnaphthalenes, polyalkylnaphthalenes.

The ester oils include diester oils such as dibutyl sebacate, di-2-ethylhexyl sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate; polyol ester oils such as trimethylolpropane caprylate, trimethylolpropane pelargonate, pentaerythritol 2-ethylhexanoate, pentaerythritol pelargonate; complex ester oils that are oligoesters of polyalcohol and mixed fatty acid of dibasic acid and monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, pentaphenyl ether, tetraphenyl ether, monoalkyltetraphenyl ether, dialkyltetraphenyl ether. Other synthetic lubricant base oils are tricresyl phosphate, silicone oil, perfluoroalkyl ether. One or more these base oils may be used herein either singly or as combined.

The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

### [Thickener]

Not specifically defined, the thickener may be any one having the ability to form a gel structure and to keep a base oil in the gel structure. For example, metal soaps, such as metal soap with any of Li and Na, composite metal soap with any of Li, Na, Ba and Ca; or non-soap such as Benton, silica gel, urea compounds, urea/urethane compounds, urethane compounds may be suitably selected and used. However, with the current rapid development of hub units, the inside of hub units may be at higher temperatures, and therefore in consideration of the heat resistance of grease, preferred are urea compounds, urea/urethane compounds, urethane compounds or their mixtures. The urea compounds include diurea compounds, triurea compounds, tetraurea compounds, polyurea compounds, urea/urethane compounds, diurethane compounds and their mixtures. Of those, preferred are diurea compounds, urea/urethane compounds, diurethane compounds or their mixtures. Even more preferably, a diurea compound is added to the composition. Preferably, the amount of the urea compound serving as a thickener is from 5 to 40 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but when the amount of the thickener is more than 40 wt %, then the grease composition may be too hard to fully exhibit its lubricating condition, and it is therefore unfavorable.

The consistency of the grease composition is preferably within a range of from 220 to 340, more preferably from 265 to 340. When it is smaller than 220, then the composition may be too hard and its lubricating effect could not be expected; but when larger than 340, then the composition may leak out from the inside of bearings.

### [Flaking Inhibitor]

Preferably, the grease composition of the invention contain poly(oxyethylene) dodecylamine [(H(OCH₂CH₂)ₙ)₂N—(CH₂)₁₁CH₃] as a flaking inhibitor. In this, n is an integer of 2 or more. The content is from 0.1 to 3 wt % of the overall amount of grease, preferably from 0.3 to 1 wt %, more preferably from 0.5 to 2 wt %. When the content is less than 0.1 wt %, then the inhibitor may be ineffective; but even though more than 3 wt %, its flaking-resisting effect may rather lower. When containing poly(oxyethylene) dodecylamine, the grease composition may have improved rustproofness, waterproofness and flaking resistance.

### [Other Additives]

Various additives may be optionally added to the grease composition of the invention for further improving its various properties. For example, one or more additives generally used in grease compositions, such as antioxidant, extreme pressure agent, oil improver, metal inactivator, may be used either singly or as combined. Not interfering with the object of the invention, any other rust inhibitor may be added to the composition.

The antioxidant includes, for example, amine compounds, phenol compounds, sulfur compounds, zinc dithiophosphate.

Examples of the amine-type antioxidant are p,p′-dioctyldiphenylamine, phenyl-1-naphthylamine, phenyl-2-naphthylamine, diphenylamine, phenylenediamine, oleylamidamine, phenothiazine.

Examples of the phenol-type antioxidant are hindered phenols such as p-t-butylphenyl salicylate, 2,6-di-t-butyl-p-phenylphenol, 2,2′-methylenebis(4-methyl-6-t-butylphenol), 4,4′-butylidenebis(6-t-butyl-m-cresol), tetrakis[methylene-3-(3′,5′-di-t-butyl-4-hydroxyphenyl)propionate]methane, 1,3,5-trimethyl-2,4,6-tris(3,5-di-t-butyl-4-hydroxybenzyl) benzene, n-octadecyl β-(4′-hydroxy-3′,5′-di-t-butylphenyl)propionate, 2-n-octyl-thio-4,6-di(4′-hydroxy-3′,5′-di-t-butyl) phenoxy-1,3,5-triazine, 4,4′-thiobis(6-t-butyl-m-cresol), 2-(2′-hydroxy-3′-t-butyl-5′-methylphenyl)-5-chlorobenzotriazole.

The oil improver includes, for example, tatty acids such as oleic acid, stearic acid; alcohols such as lauryl alcohol, oleyl alcohol; amines such as stearylamine, cetylamine; phosphates such as tricresyl phosphate; animal and vegetable oils.

In addition, an extreme pressure agent such as phosphorus compounds, zinc dithiophosphate, organic molybdenum compounds; and a metal inactivator such as benzotriazole may also be used.

The rust inhibitor includes, for example, esters Examples of the esters are sorbitan esters such as sorbitan monolaurate, sorbitan tristearate, sorbitan monooleate and sorbitan trioleate that are partial esters of polybasic carboxylic acids with polyalcohols; and alkyl esters such as polyoxyethylene laurate, polyoxyethylene oleate, polyoxyethylene stearate.

Not specifically defined, the amount of the additive may be any one not interfering with the object of the invention; and in general, it may be from 0.1 to 20 wt % of the overall amount of the grease composition. If less than 0.1 wt %, then the additive may be poorly effective; and even if more than 20 wt %, the additive effect could not increase any more, but rather since the amount of the base oil may relatively decrease, the lubrication may be poor and it is therefore unfavorable.

### [Production Method]

The method for producing the grease composition of the invention is not specifically defined. In general, however, it may be obtained by reacting a thickener in a base oil. Preferably, a predetermined amount of a flaking inhibitor is added to the base grease obtained from the base oil and the thickener. However, after the flaking inhibitor is added thereto, the mixture must be fully stirred and uniformly dispersed, using a kneader or a roll mill. Heating may be effective in this treatment. In the above production method, it is desirable from the process thereof that additives such as abrasion inhibitor and antioxidant are added to the system simultaneously with the flaking inhibitor thereto.

### FOURTH EMBODIMENT

### Grease Composition D

The grease composition for hub unit hearings of the invention contains, as the essential ingredient of the base oil therein, at least one of mineral oil and synthetic oil, and contains a thickener and a flaking inhibitor. The flaking inhibitor is bismuth 2-ethylhexylate, and its amount is preferably from 0.1 wt % to 5 wt % of the overall amount of the grease composition, more preferably from 0.5 to 2 wt %.

Since bismuth 2-ethylhexylate has good waterproofness and rustproofness, it may protect the outer raceway surfaces 21a, 21b and the inner raceway surfaces 20a, 20b of the vehicular hub unit bearing 1 from having white structure flaking or corrosion thereon, even when water is mixed in the grease composition. Accordingly, even when the vehicular hub unit bearing 1 is used in an environment in which water navy penetrate thereinto, it hardly suffers from white structure flaking or corrosion and its life is therefore long.

When the content of bismuth 2-ethylhexylate is less than 0.1 wt %, the above-mentioned effect may be insufficient; but on the other hand, even though it is more than 5 wt %, the above-mentioned effect could not increase any more and the content may be saturated. For evading such disadvantages, the content of bismuth 2-ethylhexylate is more preferably from 0.5 wt % to 3 wt %.

The type of the mineral oil and the synthetic oil to be used as the base oil of the grease composition is not specifically defined, and any oil any oil generally used as the base oil of grease composition may be used herein with no problem. The mineral oil includes paraffinic mineral oil, naphthenic mineral oil and their mixed oil; and preferred are mineral oil purified through at least one treatment of reduced-pressure distillation, oil deasphalting, solvent extraction, hydro-cracking, solvent dewaxing, sulfuric acid washing, white clay purification and hydro-refining.

The synthetic oil includes synthetic hydrocarbon oils, ester oils, ether oil, silicone oils, fluorine oils. Of those, the synthetic hydrocarbon oils include poly-α-olefins or their hydrides such as normal paraffin, isoparaffin, polybutene, polyisobutylene, 1-decene oligomer, 1-decene/ethylene co-oligomer. They also include alkylbenzenes such as monoalkylbenzenes, dialkylbenzenes, polyalkylbenzenes; and alkylnaphthalenes such as monoalkylnaphthalenes, dialkylnaphthalenes, polyalkylnaphthalenes.

The ester oils include diester oils such as dibutyl sebacate, di(2-ethylhexyl) sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate. They further include polyol ester oils such as trimethylolpropane caprylate, trimethylolpropane pelargonate, pentaerythritol 2-ethylhexanoate, pentaerythritol pelargonate; and complex aster oils that are oligoesters of polyalcohol and mixed fatty acid of dibasic acid and monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, tetraphenyl ether, pentaphenyl ether, monoalkyltetraphenyl ether, dialkyltetraphenyl ether.

Other synthetic oils than the above are tricresyl phosphate, silicone oil, perfluoroalkyl ether.

One or more these oils may be used herein either singly or as combined. The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

The type of the thickener to be in the grease composition is not specifically defined, and any one generally used as a thickener in grease compositions may be used therein with no problem. For example, herein usable are metal soaps such as lithium soap, calcium soap, aluminium soap, magnesium soap, sodium soap, and metal composite soaps such as lithium composite soap, calcium composite soap, aluminium composite soap, magnesium composite soap, sodium composite soap, barium composite soap. In addition, also usable are area compounds (e.g., diurea compounds triurea compounds, tetraurea compounds, polyurea compounds), urea/urethane compounds, urethane compounds (e.g., diurethane compounds), bentonite, silica gel. These thickeners may be used either singly or suitably as combined.

In consideration of the fact that vehicular hub unit bearing are exposed to high temperatures owing to the rapid development thereof, the grease composition must be resistant to heat. Accordingly, of those thickeners, preferred are urea compounds, urea/urethane compounds, urethane compounds or their mixtures; and of those, more preferred are diurea compounds, urea/urethane compounds, diurethane compounds or their mixtures; and even more preferred are diurea compounds.

Not specifically defined, the content of the thickener in the grease composition is preferably from 5 wt % to 40 wt %. More preferably, it is from 5 to 35 wt %, even more preferably from 5 to 25 wt %, most preferably from 8 to 25 wt %. When it is less than 5 wt %, then a semisolid grease may be difficult to produce; but when more than 40 wt %, then the grease composition may be too hard and its lubricating capability may be insufficient.

Further, any additive generally used in grease compositions may be optionally added to the grease composition. For example, it includes antioxidant, rust inhibitor, extreme pressure agent, oily agent and metal inactivator. One or more of these may be used either singly or as combined.

The antioxidant includes, for example, amine-type antioxidants, phenol-type antioxidants, sulfur-containing antioxidants, zinc dithiophosphate.

Of those, examples of the amine-type antioxidants are phenyl-1-naphthylamine, phenyl-2-naphthylamine, diphenylamine, phenylenediamine, oleylamidamine, phenothiazine.

Examples of the phenol-type antioxidants are hindered phenols such as p-t-butylphenyl salicylate, 2,6-di-t-butylphenol, 2,6-di-t-butyl-p-phenylphenol, 2,2-methylenebis(4-methyl-6-t-octhylphenol), 4,4′-butylidenebis-6-t-butyl-m-cresol, tetrakis[methylene-3-(3′,5′-di-t-butyl-4′-hydroxyphenyl)propionate]methane, 1,3,5-trimethyl-2,4,6-tris(3,5-di-t-butyl-4-hydroxybenzyl) benzene, n-octadecyl β-(4′-hydroxy-3′,5′-di-t-butylphenyl) propionate, 2-n-octyl-thio-4,6-di(4′-hydroxy-3′,5′-di-t-butyl) phenoxy-1,3,5-triazine, 4,4′-thiobis(6-t-butyl-m-cresol), 2-(2′-hydroxy-3′-t-butyl-5′-methylphenyl)-5-chlorobenzotriazole.

The rust in inhibitor includes esters. Examples of the esters are sorbitan esters such as sorbitan monolaurate, sorbitan tristearate, sorbitan monooleate and sorbitan trioleate that are partial esters of polybasic carboxylic acids with polyalcohols; and alkyl esters such as polyoxyethylene laurate, polyoxyethylene oleate, polyoxyethylene stearate.

The extreme pressure agent includes phosphorus-containing extreme pressure agent, zinc dithiophosphate, and organic molybdenum compound. The oily agent includes fatty acids such as oleic acid, stearic acid; alcohols such as lauryl alcohol, oleyl alcohol; amines such as stearylamine, cetylamine; phosphates such as tricresyl phosphate; and animal and vegetable oils. Further, the metal inactivator includes benzotriazole.

Not specifically defined, the amount of the additive in the grease composition is preferably from 0.1 wt % to 20 wt %. If less than 0.1 wt %, then the effect of the additive may be insufficient; and even if fore than 20 wt %, the additive effect could not increase any more, but rather since the amount of the base oil may relatively decrease, the lubrication may be poor.

The method for producing the grease composition is not specifically defined, to which, therefore, any method of producing ordinary grease compositions is applicable. However, the flaking inhibitor must be uniformly dispersed in the grease composition by fully stirring it with a kneader or a roll mill. In this step, stirring with heating is effective for uniform dispersion of the mixture. In case where antioxidant and other additives are added to the grease composition, it is desirable that they are added thereto simultaneously with a flaking inhibitor in view of the process of the production method.

### FIFTH EMBODIMENT

### Grease Composition Example E

Preferably, the grease composition of the invention has a mineral oil as the main base oil thereof and contains an aromatic urea serving as a thickener and calcium sulfonate, zinc dithiocarbamate, benzotriazole or its derivative serving as a flaking inhibitor. In particular, the grease composition is for vehicular hub unit bearing and is characterized in that, when it contains the above three flaking inhibitors, then its flaking-resistant life may be long even in a wetted condition, and in addition, as containing an aromatic diurea serving as a thickener, it may be effective for preventing fretting wear to be caused by driving vibration. The reason why the grease composition of the invention is excellent for flaking inhibition is not completely clarified, but it may be presumed that the suitable material balance and formulation of mineral oil, aromatic urea, calcium sulfonate, zinc dithiocarbamate, benzotriazole or its derivative may give waterproofness and strong protective film layer-forming function to grease. In addition, as containing an aromatic urea serving as a thickener, the composition may prevent fretting wear to be caused by driving vibration.

In the invention, the base oil is a mineral oil, and the thickener is an aromatic urea in consideration of resistance to fretting wear to be caused by driving vibration. The amount of the thickener, an aromatic diurea compound is preferably from 5 to 4 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but on the other hand, when more than 40 wt %, the grease composition may be too hard to sufficiently exhibit a lubricated condition, and it is therefore unfavorable.

Calcium sulfonate for use in the invention include petroleum calcium sulfonate and synthetic calcium sulfonate, for example, calcium dinonylnaphthalate sulfonate, calcium alkylbenzenesulfonate and their mixture. The total base value of calcium sulfonate may be at most 400 mgKOH/g, more preferably at most 300 mgKOH/g, even more preferably at most 100 mgKOH/g, still more preferably at most 70 mgKOH/g, most preferably at most 50 mgKOH/g.

Zinc dithiocarbamate for use in the invention includes, for example, zinc dimethyldithiocarbamate, zinc diethyldithiocarbamate, zinc dipropyldithiocarbamate, zinc dibutyldithiocarbamate, zinc dipentyldithiocarbamate, zinc dihexyldithiocarbamate, zinc diheptyldithiocarbamate, zinc dioctyldithiocarbamate, zinc dinonyldithiocarbamate, zinc didecyldithiocarbamate, zinc diundecyldithiocarbamate, zinc didodecyldithiocarbamate, zinc ditridecyldithiocarbamate, and their mixtures.

Examples of benzotriazole and its derivative for use in the invention are 1,2,3-benzotriazole, 1,H-benzotriazole, 4-methyl-1,H-benzotriazole, 4-carboxy-1,H-benzotriazole, sodium tolyltriazole, 5-methyl-1,H-benzotriazole, benzotriazole butyl ether, silver benzotriazole, 5-chloro-1,H-benzotriazole, 1-chloro-benzotriazole, 1-di(C₈H₁₇) aminomethyl-benzotriazole, 2,3-dihydroxypropyl-benzotriazole, 1,2-dicarboxyethyl-benzotriazole, (C₈H₁₇) aminomethyl-benzotriazole, bis(benzotriazol-1-yl-methyl) (C₈H₁₇) amine, N,N-bis(2-ethylhexyl)-4-methyl-1H-benzotriazole-1-methylamine, N,N-bis(2-ethylhexyl)-5-methyl-1H-benzotriazole-1-methylamine.

The content of the flaking inhibitor, calcium sulfonate, zinc dithiocarbamate, benzotriazole or its derivative, may be individually from 0.1 to 10 wt %, more preferably 0.5 to 5 wt %, even more preferably from 1 to 3 wt %, most preferably 2 wt %.

### [Other Additive]

The grease composition of the invention may optionally contain various additives added thereto for further improving its various properties. Antioxidant is especially preferred for the additive. The antioxidant includes amine-type antioxidants, phenol-type antioxidants, sulfur-containing antioxidants, zinc dithiophosphate.

Examples of the amine-type antioxidants are phenyl-1-naphthylamine, phenyl-2-naphthylamine, diphenylamine, phenylenediamine, oleylamidamine, phenothiazine. Examples of the phenol-type antioxidants are hindered phenols such as p-t-butylphenyl salicylate, 2,6-di-t-butyl-p-phenylphenol, 2,2′-methylenebis(4-methyl-6-t-octylphenol), 4,4′-butylidenebis 6-t-butyl-m-cresol, tetrakis(methylene-3-(3′,5′-di-t-butyl-4′-hydroxyphenyl)propionate methane, 1,3,5-trimethyl-2,4,6-tris(3,5-di-t-butyl-4-hydroxybenzyl) benzene, n-octadecyl β-(4′-hydroxy-3′,5′-di-t-butylphenyl)propionate, 2-n-octyl-thio-4,6-di(4′-hydroxy-3′,5′-di-t-butyl) phenoxy-1,3,5-triazine, 4,4′-thiobis(6-t-butyl-m-cresol), 2-(2′-hydroxy-3′-t-butyl-5′-methylphenyl)-5-chlorobenzotriazole.

The other additives are rust inhibitor, oil improver, extreme pressure agent. As the rust inhibitor, preferred are esters including, for example, sorbitan esters such as sorbitan monolaurate, sorbitan tristearate, sorbitan monooleate, sorbitan trioleate, and alkyl esters such as polyoxyethylene laurate, polyoxyethylene oleate, polyoxyethylene stearate.

The oil improver includes, for example, fatty acids such as oleic acid, stearic acid; alcohols such as lauryl alcohol, oleyl alcohol; amines such as stearylamine, cetylamine; phosphates such as tricresyl phosphate; and animal and vegetable oils.

The extreme pressure agent includes phosphorus compounds, zinc dithiophosphate, and organic molybdenum compounds.

One or more these additives may be added to the composition either singly or as suitably combined. The additive amount is not specifically defined so far as it falls within a range not detracting from the effect of the invention. Preferably, the amount is from 0.1 wt % to 20 wt % of the overall amount of grease. When the amount is less than 0.1 wt %, then the effect of the additive may be insufficient; and even it more than 20 wt %, the additive effect could not increase any more, but rather since the amount of the base oil may relatively decrease, the lubrication may be poor.

### [Production Method]

The method for producing the grease composition is not specifically defined, for which, in general, a thickener is reacted in a base oil. A predetermined amount of the flaking inhibitor, calcium sulfonate, zinc dithiocarbamate and benzotriazole may be added to the obtained grease, and uniformly dispersed therein by fully kneading the mixture with a kneader or a roll moll. In this treatment, heating may be effective. The other additives are preferably added to the system simultaneously with the flaking inhibitor thereto in view of the process of the production method. The consistency of the obtained grease is preferably from 220 to 340.

### SIXTH EMBODIMENT

### Grease Composition F

Preferably, the grease composition of the invention has base oil, and a thickener having a metal composite soap or an urea compound, and contains a predetermined amount of a surfactant and a metal inactivator serving as a flaking inhibitor. Not specifically defined, the base oil, the thickener, the surfactant and the metal inactivator may be combined, for example, as in the following embodiments.

### [Base Oil]

The base oil to be used is at least one of mineral oil-type lubricant oils and synthetic lubricant oils.

The mineral oil-type lubricant oil includes paraffinic mineral oils and naphthenic mineral oils; and especially preferred are those prepared through purification of reduced-pressure distillation, oil deasphalting, solvent extraction, hydro-cracking, solvent dewaxing, sulfuric acid washing, white clay purification and hydro-refining, suitably as combined. The synthetic oil-type lubricant base oil includes hydrocarbon oils, aromatic oils, ester oils, ether oils.

The hydrocarbon oils include poly-α-olefins of their hydrides such as normal paraffin, isoparaffin, polybutene, polyisobutylene, 1-decene oligomer, 1-decene/ethylene co-oligomer. The aromatic oils include alkylbenzenes such as monoalkylbenzenes, dialkylbenzenes; and alkylnaphthalenes such as monoalkylnaphthalenes, dialkylnaphthalenes, polyalkylnaphthalenes.

The ester oils include diester oils such as dibutyl sebacate, di-2-ethylhexyl sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate; polyol ester oils such as trimethylolpropane caprylate, trimethylolpropane pelargonate, pentaerythritol 2-ethylhexanoate, pentaerythritol pelargonate; complex ester oils that are oligoesters of polyalcohol and mixed fatty acid of dibasic acid/monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, pentaphenyl ether, tetraphenyl ether, monoalkyltetraphenyl ether, dialkyltetraphenyl ether. Other synthetic lubricant base oils are tricresyl phosphate, silicone oil, perfluoroalkyl ether.

The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

### [Thickener]

For the thickener, preferably used are metal complex soap or urea compounds. The metal complex soap includes metal complex soaps with any of lithium, calcium, aluminium and sodium. The urea compounds include diurea compounds, triurea compounds, tetraurea compounds, polyurea compounds, urea/urethane compounds, diurethane compounds and their mixtures. Of those, preferred are diurea compounds, urea/urethane compounds, diurethane compounds or their mixtures. Even more preferably, a diurea compound is added to the composition. Not specifically defined, the amount of the thickener to be added to the composition may any one capable of forming and keeping grease along with the base oil combined with it. Preferably, the amount is from 5 to 40 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but when the amount of the thickener is more than 40 wt %, then the grease composition may be too hard to fully exhibit its lubricating condition, and in addition, it increases torque.

### [Flaking Inhibitor]]

The surfactant for the flaking inhibitor may be selected from anionic surfactants, cationic surfactants, ampholytic surfactants and nonionic surfactants. Preferred are anionic surfactants, cationic surfactants and ampholytic surfactants as being effective for uniformly dispersing fine water droplets concretely having a size of at most 20 μm in grease and effective for keeping the oily film in a good condition at the lubricated site and for stably keeping the lubrication condition for a long period of time; and more preferred are anionic surfactants. The anionic surfactant includes alkylsulfate ester salts, polyoxyethylene alkylether sulfate ester salts, alkylbenzenesulfonate salts, alkylnaphthalenesulfonic acids, alkylsulfonesuccinic acids, fatty acid salts, naphthalenesulfonic acid/formalin condensates.

The cationic surfactant includes alkylamine salts, quaternary ammonium salts.

The ampholytic surfactant includes alkylbetaines, alkylamine oxides.

The nonionic surfactant includes alkylnaphthalenesulfonate salts, alkylsulfonatesuccinate salts. The amount of the surfactant to be added is from 0.1 to 10 wt % of the overall grease amount. When the amount is less that 0.1 wt %, then the grease could not take water as fine droplets therein, and even when it is more than 10 wt %, the increase could not produce any additional effect but rather the grease may soften and may leak out of bearings. Taking these into consideration, the amount of the surfactant to be added is preferably from 0.5 to 5 wt %, more preferably from 0.5 to 2 wt %.

The metal inactivator for the flaking inhibitor includes triazole compounds such as benzotriazole, benzimidazole, indole, methylbenzotriazole. Of those, more preferred is benzotriazole. The content of the metal inactivator is from 0.2 to 10 wt %. The metal inactivator forms a passivated film on the metal surface of rolling bearings. Accordingly, even when water penetrates into bearings, the passivated film may prevent formation of an aqueous film on the metal surface, thereby improving the flaking resistance of the metal surface. When the amount is lass than 0.2 wt %, the effect could not be attained; but even when more than 10 wt %, the effect may be saturated and could not produce any further performance improvement.

### [Other Additives]

Various additives may be optionally added to the grease composition of the invention for further improving its various properties. An antioxidant is an especially preferred additive. The antioxidant includes amine compounds, phenol compounds, sulfur compounds, zinc dithiophosphate.

Examples of the amine-type antioxidant are phenyl-1-naphthylamine, phenyl-2-naphthylamine, diphenylamine, phenylenediamine, oleylamidamine, phenothiazines.

Examples of the phenol-type antioxidant are hindered phenols such as p-t-butylphenyl salicylate, 2,6-di-t-butyl-p-phenylphenol, 2,2,′-methylenebis(4-methyl-6-t-octylphenol), 4,4′-butylidenebis-6-t-butyl-in-cresol, tetrakis[methylene-3-(3′,5′-di-t-butyl-4′-hydroxyphenyl) propionate]methane, 1,3,5-trimethyl-2,4,6-tris(3,5-di-t-butyl-4-hydroxybenzyl) benzene, n-octadecyl β-(4′-hydroxy-3′,5′-di-t-butylphenyl) propionate, 2-n-octyl-thio-4,6-di(4′-hydroxy-3′,5′-di-t-butyl)phenoxy-1,3,5-triazine, 4,4′-thiobis(6-t-butyl-m-cresol), 2-(2′-hydroxy-3′-t-butyl-5′-methylphenyl)-5-chlorobenzotriazole.

The other additives include rust inhibitor, oil improver, extreme pressure agent.

As the rust inhibitor, preferred are esters, including sorbitan esters such as sorbitan monolaurate, sorbitan tristearate, sorbitan monooleate, sorbitan trioleate, and alkyl esters such as polyoxyethylene laurate, polyoxyethylene oleate, polyoxyethylene stearate.

The oil improver includes, for example, fatty acids such as oleic acid, stearic acid; alcohols such as lauryl alcohol, oleyl alcohol; amines such as stearylamine, cetylamine; phosphates such as tricresyl phosphate; and animal and vegetable oils.

The extreme pressure agent includes phosphorus compounds, zinc dithiophosphate, and organic molybdenum compounds.

One or more these additives may be added to the composition either singly or as suitably combined. The additive amount is not specifically defined so far as it falls within a range not detracting from the effect of the invention. Preferably, the amount is from 0.1 wt % to 20 wt % of the overall amount of grease. When the amount is less than 0.1 wt %, then the effect of the additive may be insufficient; and even if more than 20 wt %, the additive effect could not increase any more, but rather since the amount of the base oil may relatively decrease, the lubrication may be poor.

### [Production Method]

The method for grease production is not specifically defined, for which, in general, a thickener is reacted in a base oil. A predetermined amount of the flaking inhibitor may be added to the obtained grease, and uniformly dispersed therein by fully kneading the mixture with a kneader or a roll moll. In this treatment, heating may be effective. The other additives are preferably added to the system simultaneously with the flaking inhibitor thereto in view of the process of the production method. The mixture consistency of the obtained grease is preferably from 220 to 340.

### SEVENTH EMBODIMENT

### Grease Composition Example G

### [Base Oil]

The base oil to be used is at least one of mineral oil-type lubricant oils and synthetic lubricant oils.

The mineral oil-type lubricant oil includes paraffinic mineral oils and naphthenic mineral oils; and especially preferred are those prepared through purification of reduced-pressure distillation, oil deasphalting, solvent extraction, hydra-cracking, solvent dewaxing, sulfuric acid washing, white clay purification and hydro-refining, suitably as combined.

The synthetic oil-type lubricant base oil includes hydrocarbon oils, aromatic oils, ester oils, ether oils.

The hydrocarbon oils include poly-α-olefins or their hydrides such as normal paraffin, isoparaffin, polybutene, polyisobutylene, 1-decene oligomer, 1-decene/ethylene co-oligomer.

The aromatic oils include alkylbenzenes such as monoalkylbenzenes, dialkylbenzenes; and alkylnaphthalenes such as monoalkylnaphthalenes, dialkylnaphthalenes, polyalkylnaphthalenes.

The ester oils include diester oils such as dibutyl sebacate, di-2-ethylhexyl sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate; polyol aster oils such as trimethylolpropane caprylate, trimethylolpropane pelargonate, pentaerythritol 2-ethylhexanoate, pentaerythritol pelargonate; complex ester oils that are oligoesters of polyalcohol and mixed fatty acid of dibasic acid/monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, pentaphenyl ether, tetraphenyl ether, monoalkyltetraphenyl ether, dialkyltetraphenyl ether. Other synthetic lubricant base oils are tricresyl phosphate, silicone oil, perfluoroalkyl ether.

The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 70 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

### [Thickener]

Not specifically defined, the thickener may be any one having the ability to form a gel structure and to keep a base oil in the gel structure. For example, metal soaps such as metal soap with any of Li and Na, or composite metal soap with any of Li, Na, Ba and Ca; or non-soap such as Benton, silica gel, urea compounds, urea/urethane compounds, urethane compounds may be suitably selected and used. However, with the current rapid development of hub units, the inside of hub units may be at higher temperatures, and therefore in consideration of the heat resistance of grease, preferred are urea compounds, urea/urethane compounds, urethane compounds or their mixtures. The urea compounds include diurea compounds, triurea compounds, tetraurea compounds, polyurea compounds, urea/urethane compounds, diurethane compounds and their mixtures. Of those, preferred are diurea compounds, urea/urethane compounds, diurethane compounds or their mixtures. Even more preferably, a diurea compound is added to the composition. Preferably, the amount of the urea compound serving as a thickener is from 5 to 40 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but when the amount of the thickener is more than 40 wt %, then the grease composition may be too hard to fully exhibit its lubricating condition, and it is therefore unfavorable.

### [Flaking Inhibitor]

An amine-type rust inhibitor having a salt of oleic acid and dicyclohexylamine is added to the grease composition of the invention, serving as a flaking inhibitor. The amount of the amine-type rust inhibitor to be added may be from 0.1 to 5 wt % of the overall amount of grease. When the amount is less than 0.1 wt %, then the inhibitor may be ineffective; but even though more than 5 wt %, its effect may not increase any more. Taking these into consideration, the amount is preferably from 0.5 to 3 wt %, more preferably from 0.5 to 2 wt %.

### [Other Additives]

Various additives may be optionally added to the grease composition of the invention for further improving its various properties. For example, one or more additives generally used in grease compositions, such as antioxidant, rust inhibitor, extreme pressure agent, oil improver, metal inactivator, may be used either singly or as combined.

The antioxidant includes, for example, amine compounds, phenol compounds, sulfur compounds, zinc dithiophosphate. Examples of the amine-type antioxidant are phenyl-1-naphthylamine, phenyl-2-naphthylamine, diphenylamine, phenylenediamine, oleylamidamine, phenothiazine.

Examples of the phenol-type antioxidant are hindered phenols such as p-t-butylphenyl salicylate, 2,6-di-t-butyl-p-phenylphenol, 2,2′-methylenebis(4-methyl-6-t-octylphenol), 4,4′-butylidenebis-6-t-butyl-m-cresol, tetrakis[methylene-3-(3′,5′-di-t-butyl-4′-hydroxyphenyl)propionate]methane, 1,3,5-trimethyl-2,4,6-tris(3,5-di-t-butyl-4-hydroxybenzyl) benzene, n-octadecyl β-(4′-hydroxy-3′,5′-di-t-butylphenyl)propionate, 2-n-octyl-thio-4,6-di(4′-hydroxy-3′, 5′-di-t-butyl)phenoxy-1,3,5-triazine, 4,4′-thiobis(6-t-butyl-m-cresol), 2-(2′-hydroxy-3′-t-butyl-5′-methylphenyl)-5-chlorobenzotriazole.

The rust inhibitor includes, for example, esters. Examples of the esters are sorbitan esters such as sorbitan monolaurate, sorbitan tristearate, sorbitan monooleate and sorbitan trioleate that are partial esters of polybasic carboxylic acids with polyalcohols; and alkyl esters such as polyoxyethylene laurate, polyoxyethylene oleate, polyoxyethylene stearate.

The oil improver includes, for example, fatty acids such as oleic acid, stearic acid, alcohols such as lauryl alcohol, oleyl alcohol; amines such as stearylamine, cetylamine; phosphates such as tricresyl phosphate; animal and vegetable oils.

In addition, an extreme pressure agent such as phosphorus compounds, zinc dithiophosphate, organic molybdenum compounds; and a metal inactivator such as benzotriazole may also be used.

Not specifically defined, the amount of the additive may be any one not interfering with the object of the invention; and in general, it may be from 0.1 to 20 wt % of the overall amount of the grease composition. If less than 0.1 wt %, then the additive may be poorly effective; and even if more than 20 wt %, the additive effect could not increase any more, but rather since the amount of the base oil may relatively decrease, the lubrication may be poor and it is therefore unfavorable.

### [Production Method]

The method for producing the grease composition of the invention is not specifically defined. In general, however, it may be obtained by reacting a thickener in a base oil. Preferably, a predetermined amount of a flaking inhibitor is added to the obtained grease composition. However, after the above additives are added thereto, the mixture must be fully stirred and uniformly dispersed, using a kneader or a roll mill. Heating may be effective in this treatment. In the above production method, it is desirable from the process thereof that additives such as abrasion inhibitor and antioxidant are added to the system simultaneously with the flaking inhibitor thereto.

### EIGHTH EMBODIMENT

### Grease Composition Example H

### [Base Oil]

The base oil to be used is at least one of mineral oil-type lubricant oils and synthetic lubricant oils.

The mineral oil-type lubricant oil includes paraffinic mineral oils and naphthenic mineral oils; and especially preferred are those prepared through purification of reduced-pressure distillation, oil deasphalting, solvent extraction, hydro-cracking, solvent dewaxing, sulfuric acid washing, white clay purification and hydro-refining, suitably as combined.

The synthetic oil-type lubricant base oil includes hydrocarbon oils, aromatic oils, ester oils, ether oils. The hydrocarbon oils include poly-α-olefins or their hydrides such as normal paraffin, isoparaffin, polybutene, polyisobutylene, 1-decene oligomer, 1-decene/ethylene co-oligomer. The aromatic oils include alkylbenzenes such as monoalkylbenzenes, dialkylbenzenes; and alkylnaphthalenes such as monoalkylnaphthalenes, dialkylnaphthalenes, polyalkylnaphthalenes. The ester oils include diester oils such as dibutyl sebacate, di-2-ethylhexyl sebacate, dioctyl adipate, diisodecyl adipate, ditridecyl adipate, ditridecyl glutarate, methyl acetylcinnolate; aromatic ester oils such as trioctyl trimellitate, tridecyl trimellitate, tetraoctyl pyromellitate; polyol ester oils such as trimethylolpropane caprylate, trimethylolpropane pelargonate, pentaerythritol 2-ethylhexanoate, pentaerythritol pelargonate; complex ester oils that are oligoesters of polyalcohol and mixed fatty acid of dibasic acid/monobasic acid.

The ether oils include polyglycols such as polyethylene glycol, polypropylene glycol, polyethylene glycol monoether, polypropylene glycol monoether; phenyl ether oils such as monoalkyltriphenyl ether, alkyldiphenyl ether, dialkyldiphenyl ether, pentaphenyl ether, tetraphenyl ether, monoalkyltetraphenyl ether, dialkyltetraphenyl ether. Other synthetic lubricant base oils are tricresyl phosphate, silicone oil, perfluoroalkyl ether.

The kinematic viscosity of the base oil at 40° C. is preferably from 40 mm²/sec to 250 mm²/sec, for the purpose of evading noise generation in starting at low temperature and evading seizure to be caused by the difficulty in forming oily film at high temperature. More preferably it is from 50 mm²/sec to 150 mm²/sec, even more preferably from 75 mm²/sec to 120 mm²/sec, most preferably from 75 mm²/sec to 110 mm²/sec. In case where the composition is used at high temperatures, for example, in a tropical area, the kinematic viscosity is preferably from 100 mm²/sec to 250 mm²/sec. When less than 40 mm²/sec, then it is unfavorable in view of the waterproofness of the composition; and when more than 250 mm²/sec, then the torque may increase and therefore it is unfavorable from the viewpoint of heat resistance.

### [Thickener]

Not specifically defined, the thickener may be any one having the ability to form a gel structure and to keep a base oil in the gel structure. For example, metal soaps such as metal soap with any of Li and Na, or composite metal soap with any of Li, Na, Ea and Ca; or non-soap such as Benton, silica gel, urea compounds, urea/urethane compounds, urethane compounds may be suitably selected and used; however, with the current rapid development of hub units, the inside of hub units may be at higher temperatures, and therefore in consideration of the heat resistance of grease, preferred are urea compounds, urea/urethane compounds, urethane compounds or their mixtures. The urea compounds include diurea compounds, triurea compounds, tetraurea compounds, polyurea compounds, urea/urethane compounds, diurethane compounds and their mixtures. Of those, preferred are diurea compounds, urea/urethane compounds, diurethane compounds or their mixtures. Even more preferably, a diurea compound is added to the composition. Preferably, the amount of the urea compound serving as a thickener is from 5 to 40 wt % of the overall amount of grease. More preferably, it is from 5 to 35 wt %, even more preferably from 5 to 25 wt %, most preferably from 8 to 25 wt %. When the amount of the thickener is less than 5 wt %, then the composition could hardly keep its grease condition; but when the amount of the thickener is more than 40 wt %, then the grease composition may be too hard to fully exhibit its lubricating condition, and it is therefore unfavorable.

### [Flaking Inhibitor]

The grease composition of the invention preferably contains a carboxylic acid anhydride serving as a flaking inhibitor. The carboxylic acid anhydride is preferably alkenylsuccinic acid anhydride. The alkenyl group in the alkenylsuccinic acid anhydride preferably has from 6 to 30 carbon atoms, more preferably 8 or 12 carbon atoms, most preferably 8 carbon atoms. The amount of alkenylsuccinic acid anhydride to be added may be from 0.1 to 5 wt % of the overall amount of grease. When the amount is less than 0.1 wt %, then the inhibitor may be ineffective; but even though more than 5 wt %, its effect may not increase any more. Taking these into consideration, the amount is preferably from 0.5 to 3 wt %, more preferably from 0.5 to 2 wt %.

### [Other Additives]

Various additives may be optionally added to the grease composition off the invention for further improving its various properties. For example, one or more additives generally used in grease compositions, such as antioxidant, rust inhibitor, extreme pressure agent, oil improver, metal inactivator, may be used either singly or as combined.

The antioxidant includes, for example, amine compounds, phenol compounds, sulfur compounds, zinc dithiophosphate. Examples of the amine-type antioxidant are phenyl-1-naphthylamine, phenyl-2-naphthylamine, diphenylamine, phenylenediamine, oleylamidamine, phenothiazine.

Examples of the phenol-type antioxidant are hindered phenols such as p-t-butylphenyl salicylate, 2,6-di-t-butyl-p-phenylphenol, 2,2′-methylenebis(4-methyl-6-t-octylphenol), 4,4′-butylidenebis-6-t-butyl-m-cresol, tetrakis[methylene-3-(3′,5′-di-t-butyl-4′-hydroxyphenyl)propionate]methane, 1,3,5-trimethyl-2,4,6-tris(3,5-di-t-butyl-4-hydroxybenzyl) benzene, n-octadecyl β-(4′-hydroxy-3′,5′-di-t-butylphenyl)propionate, 2-n-octyl-thio-4,6-di(4′-hydroxy-3′,5′-di-t-butyl)phenoxy-1,3,5-triazine, 4,4′-thiobis(6-t-butyl-m-cresol), 2-(2′-hydroxy-3′-t-butyl-5′-methylphenyl)-5-chlorobenzotriazole.

The rust inhibitor includes, for example, esters. Examples of the esters are sorbitan esters such as sorbitan monolaurate, sorbitan tristearate, sorbitan monooleate and sorbitan trioleate that are partial esters of polybasic carboxylic acids with polyalcohols; and alkyl esters such as polyoxyethylene laurate, polyoxyethylene oleate, polyoxyethylene stearate.

The oil improver includes, for example, fatty acids such as oleic acid, stearic acid; alcohols such as lauryl alcohol, oleyl alcohol; amines such as stearylamine, cetylamine; phosphates such as tricresyl phosphate; animal and vegetable oils.

In addition, an extreme pressure agent such as phosphorus compounds, zinc dithiophosphate, organic molybdenum compounds; and a metal inactivator such as benzotriazole may also be used.

Not specifically defined, the amount of the additive may be any one not interfering with the object of the invention; and in general, it may be from 0.1 to 20 wt % of the overall amount of the grease composition. If less than 0.1 wt %, then the additive may be poorly effective; and even if more than 20 wt %, the additive effect could not increase any more, but rather since the amount of the base oil may relatively decrease, the lubrication may be poor and it is therefore unfavorable.

### [Production Method]

The method for producing the grease composition of the invention is not specifically defined. In general, however, it may be obtained by reacting a thickener in a base oil. Preferably, a predetermined amount of a flaking inhibitor is added to the obtained grease composition. However, after the flaking inhibitor is added thereto, the mixture must be fully stirred and uniformly dispersed, using a kneader or a roll mill. Heating may be effective in this treatment. In the above production method, it is desirable from the process thereof that additives such as abrasion inhibitor and antioxidant are added to the system simultaneously with the flaking inhibitor thereto.

### EXAMPLES

The invention is described more concretely with reference to the following Examples and Comparative Examples, which, however, do not whatsoever restrict the scope of the invention.

### Example A

The above Embodiment 1 was subjected to a bearing waterproofness test, and this is described below.

First, grease composition samples of Examples A1 to A4 and Comparative Examples A1 and A2 were prepared, according to the formulation shown in Table 1. To all the grease composition samples, added were an amine-type antioxidant (p,p′-dioctyldiphenylamine, Vanlube 81 (by Vanderbit)) and a rust inhibitor (zinc naphthenate, Naphthex Zinc (by Nippon Chemical Industry)), in an amount of 1.0 wt % each.

Next, the grease composition samples prepared in the manner as above were tested for bearing waterproofness. The bearing waterproofness test is as follows: A grease composition sample is sealed up in a tapered roller bearing by NSK (HR32017 (inner diameter 85 mm, outer diameter 130 mm, width 29 mm)), and the bearing is rotated under a radial load of 35.8 kN and an axial load of 15.7 kN and at a revolution speed of 1500 min⁻¹. During the test, water is filled in the bearing from the outside at a rate of 1 wt %/sec. After the bearing has been thus continuously rotated for 100 hours, the test is stopped, and the bearing is checked for flaking. Before the test, the consistency of each grease composition is measured. The measured results and the test results are all shown in Table 1.

TABLE 1

| | | | | | | Comparative | Comparative |
|---|---|---|---|---|---|---|---|
| | | Example A1 | Example A2 | Example A3 | Example A4 | Example A1 | Example A2 |
| Thickener | diurea¹⁾ | 12 | 12 | 13 | | 15 | |
| (mas. %) | lithium | | | | 12 | | 12 |
| | composite | | | | | | |
| | soap²⁾ | | | | | | |
| Base Oil | mineral oil³⁾ | 84 | 42 | 60 | 84 | 83 | 43 |
| (mas. %) | poly-α-olefin | | 42 | 23 | | | 43 |
| | oil⁴⁾ | | | | | | |
| Kinematic Viscosity at 40° C. | | 98.3 | 97.6 | 108.3 | 98.3 | 98.3 | 98.5 |
| (mm²/sec) | | | | | | | |
| Additive | benzotriazole⁵⁾ | 2 | 2 | 2 | 2 | | |
| (mas. %) | antioxidant⁶⁾ | 1 | 1 | 1 | 1 | 1 | 1 |
| | rust | 1 | 1 | 1 | 1 | 1 | 1 |
| | inhibitor⁷⁾ | | | | | | |

| | | | | | | |
|---|---|---|---|---|---|---|
| Consistency | 280 | 277 | 275 | 270 | 279 | 265 |
| Bearing Waterproofness Test: | no | no | no | no | yes | yes |
| flaking | | | | | | |

¹⁾diurea formed, by reaction of 4,4′-diphenylmethane diisocyanate and cyclohexylamine
²⁾lithium composite soap with 12-hydroxystearic acid/azelaic acid = 75 mas. %/25 mas. %
³⁾mineral oil, having kinematic viscosity at 40° C. of 98.3 mm²/sec.
⁴⁾poly-α-olefln oil, having a kinematic viscosity at 40° C. of 98.7 mm²/sec.
⁵⁾benzotriazole (by Jyohoku Chemical).
⁶⁾Vanlube 81 (by Vanderbit).
⁷⁾Napthex Zinc (by Nippon chemical Industry).

As in Table 1, flaking occurred in Comparative Examples, but in Examples, no flaking occurred. This confirms that the invention ensures excellent waterproofness and flaking resistance, therefore confirming prolonged life of bearings.

### Example B

The above Embodiment 2 was tested, as described below.

### Examples B1, B2

A mineral oil was used as a base oil, and this was reacted with a diurea formed through reaction of 4,4-diphenylmethane diisocyanate and p-toluidine, and then stirred under heat to obtain a urea-type base grease. After left cooled, oleoyl sarcosine (by Nippon Yushi) was added to the base grease in such a manner that its amount added could be 1 wt %, and then stirred and defoamed to obtain a grease sample (Example B1). In the same manner as above but using a mixed oil of a mineral oil and a poly-α-olefin oil as the base oil, another grease sample (Example B2) was prepared.

### Comparative Examples B1 to B3

For comparison, a grease sample of the above urea-type base grease alone (Comparative Example B1); a grease sample containing 1 wt % of a rust inhibitor, barium sulfonate (Nihon Seika) added to the urea-type base grease (Comparative Example B2); and a grease sample containing 1 wt % of a rust inhibitor, barium sulfonate added to an urea-type base grease containing a mixed oil of a mineral oil and a poly-α-olefin oil as the base oil thereof (Comparative Example 23) were prepared according to the above-mentioned method.

All grease samples contained 1 wt % of an amine-type antioxidant (p,p′-dioctyldiphenylamine, by Tokyo Kasei) added thereto.

### (Test for Rust Inhibition)

A grease sample is sealed up in ball bearing “608” of NSK to a level of 20 W of the space volume, and left for one week in a high-humidity constant-temperature bath (test condition: temperature 80° C., humidity 90%), and the inner ring is visually checked for rusting. The tested samples are ranked as follows, based on the number of rusty spots.

A: No rust.

B: From 1 to 5 rusty spots.

C: 6 or more rusty spots.

### (Bearing Waterproofness Test)

A grease sample is sealed up in a tapered roller bearing by NSK (HR32017 (inner diameter 85 mm, outer diameter 130 mm)), and the bearing is continuously rotated under a radial load of 35.8 kN and an axial load of 15.7 kN and at a revolution speed of 1500 rpm with water being introduced into it from the outside at a rate of 20 ml/hr. At the time when the outer ring running surface of the bearing has flaked to give vibration, or after 100 hours with no flaking, the test is stopped. One grease sample is tested 10 times in the manner, and the flaking probability is obtained according to the following formula:

Flaking Probability (%)=(number of flaked samples/number of tested samples)×100

The test results are shown in Table 2.

TABLE 2

| | | | | Comparative | Comparative | Comparative |
|---|---|---|---|---|---|---|
| | | Example B1 | Example B2 | Example B1 | Example B2 | Example B3 |
| Base Oil | mineral oil | 80 | 50 | 81 | 80 | 50 |
| | (mas. %)¹⁾ | | | | | |
| | poly-α-olefin | — | 30 | — | — | 30 |
| | oil (mas. %)²⁾ | | | | | |

| | | | | | |
|---|---|---|---|---|---|
| Thickener (mas. %)³⁾ | 18 | 18 | 18 | 18 | 18 |
| Antioxidant (mas. %)⁴⁾ | 1 | 1 | 1 | 1 | 1 |
| Oleoyl Sarcosine (mas. %) | 1 | 1 | — | — | — |
| Barium Sulfonate (mas. %) | — | | — | 1 | 1 |
| Flaking Possibility (%) after | 0 | 0 | 50 | 100 | 100 |
| Bearing Waterproofness Test | | | | | |
| Rank of Rusting Resistance | A | A | C | A | A |
| Mixture Consistency | 280 | 271 | 283 | 280 | 277 |

¹⁾mineral oil, having a kinematic viscosity at 40° C. of 98.3 mm²/sec
²⁾poly-α-olefin oil, having a kinematic viscosity at 40° C. of 98.7 mm²/sec
³⁾diurea formed, through reaction of 4,4-diphenylmethane diisocyanate and p-toluidine
⁴⁾p,p′-dioctyldiphenylamine, by Tokyo Kaisei

From Table 2, it is understood that the grease with oleoyl sarcosine added thereto has not only excellent flaking resistance but also excellent corrosion resistance. As opposed to this, it is understood that the sample with no oleoyl sarcosine and the sample containing barium sulfonate as a rust inhibitor could not have sufficient flaking resistance and corrosion resistance.

### Example C

The above Embodiment 3 was tested, as described below.

### Examples C1, C2

A mineral oil was used as a base oil, and this was reacted with a diurea formed through reaction of 4,4-diphenylmethane diisocyanate and p-toluidine, and then stirred under heat to obtain a urea-type base grease. After left cooled, the above-mentioned poly(oxyethylene)dodecylamine having n of 2 or more (Nymeen by Nippon Yushi) was added to the base grease in such a manner that its amount added could be 1 wt %, and then stirred and defoamed to obtain a grease sample (Example C1).

### Comparative Examples C1 to C3

For comparison, a grease sample of the above urea-type base grease alone (Comparative Example C1); a grease sample containing 1 wt % of a rust inhibitor, barium sulfonate (by Nihon Seika) added to the urea-type base grease (Comparative Example C2); and a grease sample containing 5 wt % of poly(oxyethylene) dodecylamine added thereto (Comparative Example C3) were prepared according to the above-mentioned method.

All grease samples contained 1.0 wt % of an amine-type antioxidant (p,p′-dioctyldiphenylamine, by Tokyo Kasei) added thereto.

### (Test for Rust Inhibition)

A grease sample is sealed up in ball bearing “608” of NSK to a level of 20% of the space volume, and left for one week in a high-humidity constant-temperature bath (test condition: temperature 80° C., humidity 90%), and the inner ring is visually checked for rusting. The tested samples are ranked as follows, based on the number of rusty spots.

A: No rust.

B: From 1 to 5 rusty spots.

C: 6 or more rusty spots.

### (Bearing Waterproofness Test)

A grease sample is sealed up in a tapered roller bearing by NSK (HR32017 (inner diameter 85 mm, outer diameter 130 mm)), and the bearing is continuously rotated under a radial load of 35.8 kN and an axial load of 15.7 kN and at a revolution speed of 1500 rpm with water being introduced into it from the outside at a rate of 20 ml/hr. At the time when the outer ring running surface of the bearing has flaked to give vibration, or after 100 hours with no flaking, the test is stopped. One grease sample is tested 10 times in the manner, and the flaking probability is obtained according to the following formula:

Flaking Probability (%)=(number of flaked samples/number of tested samples)×100.

The test results are shown in Table 3.

TABLE 3

| | | Comparative | Comparative | Comparative |
|---|---|---|---|---|
| | Example C1 | Example C1 | Example C2 | Example C3 |
| Mineral Oil (mas. %)¹⁾ | 80 | 81 | 80 | 76 |
| Thickener (mas. %)²⁾ | 18 | 18 | 18 | 18 |
| Antioxidant (mas. %)³⁾ | 1 | 1 | 1 | 1 |
| Poly(oxyethylene)dodecylamine | 1 | — | — | 5 |
| (mas. %) | | | | |
| Barium Sulfonate (mas. %) | — | — | 1 | — |
| Flaking Possibility (%) after | 0 | 50 | 100 | 50 |
| Bearing Waterproofness Test | | | | |
| Rank of Rusting Resistance | A | C | A | A |
| Mixture Consistency | 277 | 283 | 280 | 293 |

¹⁾mineral oil, having a kinematic viscosity at 40° C. of 98.3 mm²/sec.
²⁾diurea formed through reaction of 4,4-diphenylmethane diisocyanate and p-toluidine.
³⁾p,p′-dioctyldiphenylamine, by Tokyo Kasei.

From Table 3, it is understood that the grease that contains poly(oxyethylene)dodecyl amine within the range of the invention has not only excellent flaking resistance but also excellent corrosion resistance. As opposed to this, it is understood that the sample with no poly(oxyethylene)dodecylamine, the sample containing barium sulfonate as a rust inhibitor/and the sample containing an excessive amount of poly(oxyethylene)dodecylamine could not have sufficient flaking resistance and corrosion resistance.

### Example D

The above Embodiment 4 was tested, as described below.

Five grease compositions differing in the constitution (see Table 4) were prepared, and evaluated for their properties.

TABLE 4

| | | | | Comparative | Comparative | Comparative |
|---|---|---|---|---|---|---|
| | | Example D1 | Example D2 | Example D1 | Example D2 | Example D3 |
| Base Oil | mineral oil | 80 | 50 | 81 | 80 | 50 |
| | poly-α-olefin | — | 30 | — | — | 30 |
| | oil | | | | | |

| | | | | | |
|---|---|---|---|---|---|
| Thickener | 18 | 18 | 18 | 18 | 18 |
| Bismuth 2-Ethylhexylate | 1 | 1 | — | — | — |
| Antioxidant | 1 | 1 | 1 | 1 | 1 |
| Rust Inhibitor | — | — | — | 1 | 1 |
| Result of Waterproofness Test (%) | 0 | 0 | 50 | 100 | 100 |
| Test for Rust Inhibition | A | A | C | A | A |

*) Except for the result of waterproofness test, the unit of the numeral value is wt %.

The constitution of the grease compositions is described. The grease compositions of Examples D1 and D2 contain a base oil of at least one of mineral oil and poly-α-olefin oil, a thickener of diurea compound, and bismuth 2-ethylhexylate, and further contain an antioxidant as additive, as in Table 4. The grease composition of Comparative Example D1 does not contain bismuth 2-ethylhexylate; and the grease compositions of Comparative Examples D2 and D3 contain a rust inhibitor in place of bismuth 2-ethylhexylate.

The mineral oil, the poly-α-olefin oil, the diurea compound, the antioxidant and the rust inhibitor used herein are as follows:
Mineral oil, having a kinematic viscosity at 40° C. of 98.3 mm²/sec
Poly-α-olefin oil, having a kinematic viscosity at 40° C. of 98.7 mm²/sec
Diurea compound, obtained through reaction of 4,4-diphenylmethane diisocyanate and p-toluidine
Antioxidant, p,p′-dioctyldiphenylamine by Tokyo Kasei Industry
Rust inhibitor, barium sulfonate by Nihon Seika

These grease compositions were produced as follows: First, a base oil containing 4,4′-diphenylmethane diisocyanate and a base oil containing p-toluidins were mixed, and then stirred under heat to obtain a base grease. The base grease was cooled, and then bismuth 2-ethylhexylate and antioxidant (in Comparative Examples, antioxidant alone, or antioxidant and rust inhibitor) were added to it, stirred and defoamed to obtain a grease composition for test. The mixture consistency (25° C.) of the grease composition was controlled to correspond to NLGI Consistency Number 2.

These grease compositions were tested for rust inhibition and waterproofness. The test methods are described below.

### [Regarding Test for Rust Inhibition]

A grease composition of Example D1 and D2 and Comparative Examples D1 to D3 is filled in an NSK's hall bearing, nominal number 608, up to a level of 20% of the bearing space volume, and the ball bearing was then left for 7 days in a constant temperature/humidity bath controlled at a temperature of 80° C. and a humidity of 90% RH. Then, the ball bearing was disassembled, and the raceway surface of the inner ring was visually checked for rusting. The tested samples are ranked as follows, based on the number of rusty spots.

A: No rust.

B; From 1 to 5 rusty spots.

C: 6 or more rusty spots.

### (Regarding Waterproofness Test)

A grease composition; of Examples 1 and 2 and Comparative Examples 1 to 3 is filled in an NSK's ball bearing (nominal number HR32017 inner diameter 85 mm, outer diameter 130 mm, width 29 mm). The bearing is rotated under a radial load of 35.8 kN and an axial load of 15.7 kN and at a revolution speed of 1500 rpm. During the rotation test, water is continuously filled into the inner space (vacant part) of the bearing at a rate of 20 ml/hr.

The time taken until the raceway surface of the outer ring has flaked to give vibration is measured. However, when no flaking has occurred after the rotation test for 100 hours, the rotation test is stopped. One grease composition is tested 10 times in the manner, and the proportion of the flaked bearings is computed.

The test results are shown in Table 4. As is known from Table 4, the bearings filled with the grease composition of Examples D1 and D2 containing bismuth 2-ethylhexylate were more hardly flaked and had a longer life even when used in the environment in which water may penetrate into them, as compared with the bearing filled with the grease composition of Comparative Examples D1 to D3. In addition, they were hardly corroded.

### Example E

The above Embodiment 5 was tested, as described below.

### Example E1, Comparative Examples E1 to E9

A mineral oil mixed with p-toluidine was added to and reacted with a mineral oil mixed with 4,4′-diphenylmethane diisocyanate, and stirred under heat to prepare an aromatic urea base grease. (In comparative Examples E8 and E9, an aliphatic Urea base grease prepared from 4,4′-diphenylmethane diisocyanate and stearylamine was used.) After gradually cooled, various additives were added to it in the ratio as in Table 5, stirred and well kneaded with a roll mill, and then defoamed to obtain a grease sample. The consistency of the grease sample was controlled to be NLGI No. 1 to 3. The grease sample was tested for bearing waterproofness and fretting resistance in the manner mentioned below.

### (Bearing Waterproofness Test)

A tapered roller bearing HR32017 (inner diameter, 85 mm; outer diameter, 130 mm) is used. This is rotated under a radial load of 35.8 kN and an axial load of 15.7 kN at a revolution speed of 1500 rpm while water is introduced into the bearing from the outside at a rate of 20 ml/hr, and tested for flaking resistance. The flaking test is continued for an intended period of 100 hours. At the time when the outer ring rolling surface of the bearing has flaked to give vibration, or after 100 hours with no flaking, the test is stopped. One grease sample is tested 10 times in the manner, and the flaking probability is computed according to the following formula:

Flaking Probability (%)=(number of flaked samples/number of tested samples)×100.

### [Fretting Resistance Test]

A fretting resistance test is carried out according to the test method stipulated in ASTM D4170, and the weight change is determined. In this test, the mass difference of the test piece before and after the test is determined, and based on the mass difference, the tested samples are ranked in three ranks and evaluated, For use in vehicles, those on the following rank A and the rank A are desirable, and the rank A samples and the rank B samples are good.
Rank A: The weight reduction is at most 3 mg.
Rank B: The weight reduction is more than 3 mg and less than 5 mg.
Rank C: The weight reduction is 5 mg or more.

TABLE 5

| | | | Comparative | Comparative | Comparative | Comparative |
|---|---|---|---|---|---|---|
| | | Example E1 | Example E1 | Example E2 | Example E3 | Example E4 |
| Base Oil; mineral oil¹⁾ | | balance | balance | balance | balance | balance |
| Thickener | aromatic | 19.0 | 19.0 | 19.0 | 19.0 | 19.0 |
| | diurea²⁾ | | | | | |
| | aliphatic | — | — | — | — | — |
| | diurea³⁾ | | | | | |
| Calcium | | 2.0 | 1.0 | 2.0 | — | — |
| Dinonylnaphthalenesulfonate⁴⁾ | | | | | | |
| Zinc Dipentyldithiocarbamate | | 2.0 | 1.0 | — | 2.0 | — |
| N,N-bis(2-ethylhexyl)-4- | | 2.0 | 1.0 | — | — | 2.0 |
| methyl-1H-benzotriazole- | | | | | | |
| 1-methylamine | | | | | | |
| Diphenylamine | | 0.3 | 0.3 | 0.3 | 0.3 | 0.3 |
| Aliphatic Amine Salt | | 0.3 | 0.3 | 0.3 | 0.3 | 0.3 |
| Flaking Probability (%) | | 0 | 10 | 80 | 50 | 60 |
| Fretting Resistance Test | | A | A | B | A | B |
| | | Comparative | Comparative | Comparative | Comparative | Comparative |
| | | Example E5 | Example E6 | Example E7 | Example E8 | Example E9 |
| Base Oil; mineral oil¹⁾ | | balance | balance | balance | balance | balance |
| Thickener | aromatic | 19.0 | 19.0 | 19.0 | — | — |
| | diurea²⁾ | | | | | |
| | aliphatic | — | — | — | 12.0 | 12.0 |
| | diurea³⁾ | | | | | |

| | | | | | |
|---|---|---|---|---|---|
| Calcium | 2.0 | 2.0 | — | 2.0 | 2.0 |
| Dinonylnaphthalenesulfonate⁴⁾ | | | | | |
| Zinc Dipentyldithiocarbamate | 2.0 | — | 2.0 | 2.0 | — |
| N,N-bis(2-ethylhexyl)-4- | — | 2.0 | 2.0 | 2.0 | — |
| methyl-1H-benzotriazole- | | | | | |
| 1-methylamime | | | | | |
| Diphenylamine | 0.3 | 0.3 | 0.3 | 0.3 | 0.3 |
| Aliphatic Amine Salt | 0.3 | 0.3 | 0.3 | 0.3 | 0.3 |
| Flaking Probability (%) | 50 | 30 | 30 | 20 | 80 |
| Fretting Resistance Test | A | A | A | C | C |

Notes)
The unit is wt % (except for the value of flaking probability).
¹⁾Mineral oil, having a kinematic viscosity at 40° C. of 75 mm²/sec.
²⁾Diurea produced through reaction of 4,4′-diphenylmethane diisocyanate and p-toluidine.
³⁾Diurea produced through reaction of 4,4′-diphenylmethane diisocyanate and stearylamine.
⁴⁾Neutral.

From Table 5, it is understood that the grease that contains the aromatic diurea as a thickener and contains three of calcium sulfonate, zinc dithiocarbamate and benzotriazole in an amount of 2% each as a flaking inhibitor has excellent flaking resistance and fretting resistance and therefore can keep good lubrication condition for a long period of time. As in the above result, the vehicular hub unit bearing that contains the waterproof grease composition of the invention may have a prolonged bearing life.

### Example F

The above Embodiment 6 was tested, as described below.

### Examples F1 to F4, Comparative Examples F1 and F2

A mineral oil mixed with p-toluidine was added to and reacted with a mineral oil mixed with 4,4′-diphenylmethane diisocyanate, and stirred under heat to prepare an aromatic urea grease. After gradually cooled, surfactant, metal inactivator and antioxidant were added to it in the ratio as in Table 6, stirred and then defoamed to obtain a grease sample. The consistency of the grease sample was controlled to be NLGI No. 1 to 3. The grease sample was tested according to a wet shell toll test and a bearing waterproofness test as mentioned below.

### (Wet Shell Roll Test)

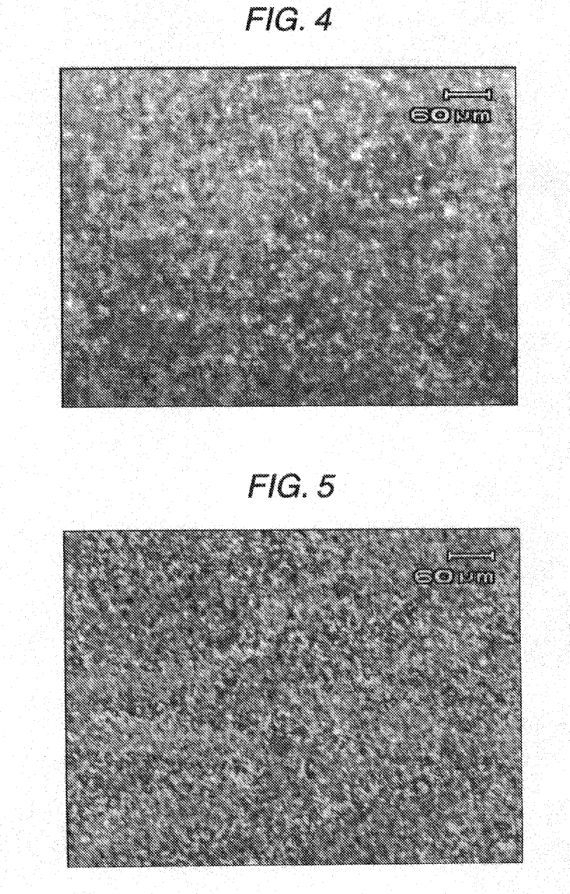

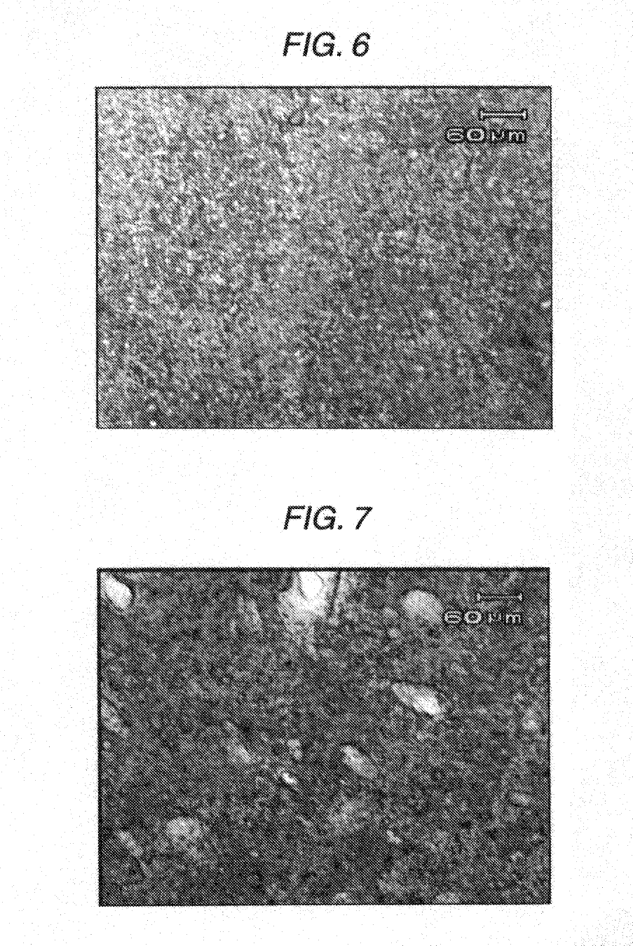

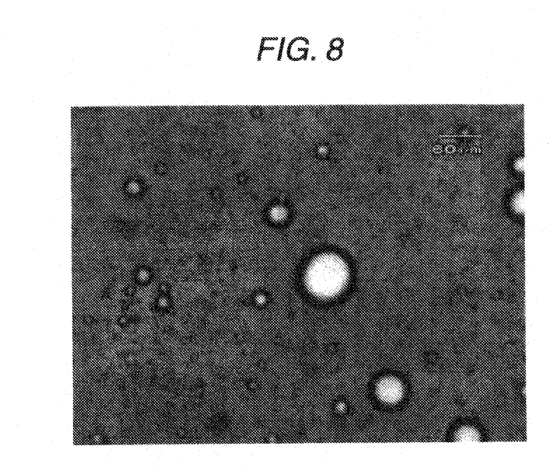

50 g of a grease sample and 10 g of ion-exchanged water are put into a shell roll tester, and subjected to a wet shell roll test at a revolution speed of 165 rpm and at a temperature of 40° C. for 2 hours. Then, the particle size of water in the grease was measured with an optical microscope. The results are shown in Table 6. In addition, photographic pictures of the condition of grease are in FIG. 4 to FIG. 8.

### (Bearing Waterproofness Test)

A tapered roller bearing HR32017 (inner diameter, 85 mm; outer diameter, 130 mm) is used. This is rotated under a radial load of 35.8 kN and an axial load of 15.7 kN at a revolution speed of 1500 rpm while water is introduced into the bearing from the outside at a rate of 20 ml/hr, and tested for flaking resistance. The flaking test is continued for an intended period of 100 hours. At the time when the outer ring rolling surface of the bearing has flaked to give vibration, or after 100 hours with no flaking, the test is stopped. One grease sample is tested 10 times in the manner, and the flaking probability is computed according to the following formula:

Flaking Probability (%)=(number of flaked samples/number of tested samples)×100.

TABLE 6

| | | | | | | Comparative | Comparative |
|---|---|---|---|---|---|---|---|
| | | Example F1 | Example F2 | Example F3 | Example F4 | Example F1 | Example F2 |
| Base Oil: mineral oil¹⁾ | | 79 | 79 | 79 | 79 | 81 | 80 |
| Thickener: aromatic diurea | | 18 | 18 | 18 | 18 | 18 | 18 |
| (mas. %)²⁾ | | | | | | | |
| Antioxidant³⁾ (mas. %) | | 1 | 1 | 1 | 1 | 1 | 1 |
| Surfactant | Type | anionic⁴⁾ | cationic⁵⁾ | ampholytic⁶⁾ | nonionic⁷⁾ | — | — |
| | Amount | 1 | 1 | 1 | 1 | — | — |
| | (mas. %) | | | | | | |

| | | | | | | |
|---|---|---|---|---|---|---|
| Metal Inactivator⁸⁾ | 1 | 1 | 1 | 1 | — | 1 |
| Particle Size of Water | 20 or less | 20 or less | 20 or less | 5 to 60 | 10 to 60 | — |
| Droplets (μm) | | | | | | |
| Flaking Probability (%) | 0 | 20 | 20 | 40 | 100 | 50 |

Notes:
¹⁾Mineral oil, having a kinematic viscosity at 40° C. of 98.3 mm²/sec.
²⁾Diurea formed through reaction of 4,4′-diphenylmethane diisocyanate and p-toluidine.
³⁾p,p′-dioctyldiphenylamine, by Tokyo Kasei.
⁴⁾Alkylbenzenesulfonate salt, by Kao.
⁵⁾Quaternary ammonium salt, by Kao.
⁶⁾Alkylbetaine, by Kao.
⁷⁾Polyoxyethylene alkyl ether, by Kao.
⁸⁾Benzotriazole, by Jyohoku Chemical.

From Table 6, it is understood that the greases of Examples F1 to F3 containing 1% of anionic, cationic or ampholytic surfactant capable of dispersing water in grease as fine particles, and 1% of benzotriazole capable forming a passivated film on the surface of a bearing, in particular, the grease of Example F1 containing anionic surfactant have excellent flaking resistance and can keep good lubrication condition for a long period of time. As opposed to these, it is understood that the samples not containing surfactant and metal inactivator could not have satisfactory flaking resistance.

### Example G

The above Embodiment 7 was tested, as described below.

### Examples G1 and G2

A mineral oil mixed with amine was reacted with a mineral oil mixed with diisocyanate, and stirred under heat to prepare an urea-type base grease. After gradually cooled, an amine-type rust inhibitor containing a salt of oleic acid and dicyclohexylamine was added to the base grease in an amount of 1 wt %, then stirred and defoamed to obtain a grease sample. In the same manner but using a mixed oil of a mineral oil and a poly-α-olefin oil as the base oil, another urea-type grease was produced.

### Comparative Examples G1 to G3

For comparison, a grease sample of the above urea-type base grease alone (Comparative Example G1), a grease sample Containing 1 wt % of a rust inhibitor, barium sulfonate (by Nihon Seika) added to the urea-type base grease (Comparative Example G2); and a grease sample having 1 wt % of a rust inhibitor, barium sulfonate added to an urea-type base grease containing a mixed oil of a mineral oil and a poly-α-olefin oil as the bass oil thereof (Comparative Example G3) were prepared according to the above-mentioned method.

All grease samples were controlled to have a consistency of NLGI No. 2. They contained 1 wt % of an amine-type antioxidant (p,p′-dioctyldiphenylamine, by Tokyo Kasei) added thereto.

### (Test for Rust Inhibition)

A grease sample is sealed up in ball bearing “608” of NSK to a level of 20% of the space volume, and left for one week in a constant temperature/humidity bath (test condition: temperature 80° C., humidity 90%), and the inner ring is visually checked for rusting. The tested samples are ranked as follows, based on the number of rusty spots.

A: No rust.

B: From 1 to 5 rusty spots.

C: 6 or more rusty spots.

### (Bearing Waterproofness Test)

A grease sample is sealed up in a tapered roller bearing by NSK (HR32017 (inner diameter 85 mm, outer diameter 130 mm)), and the bearing is continuously rotated under a radial load of 35.8 kN and an axial load of 15.7 kN and at a revolution speed of 1500 rpm with water being introduced into it from the outside at a rate of 20 ml/hr. The flaking test is continued for an intended period of 100 hours. At the time when the outer ring running surface of the bearing has flaked to give vibration, or after 100 hours with no flaking, the test is stopped. One grease sample is tested 10 times in the manner, and the flaking probability is obtained according to the following formula:

Flaking Probability (%)=(number of flaked samples/number of tested samples)×100.

TABLE 7

| | | | | Comparative | Comparative | Comparative |
|---|---|---|---|---|---|---|
| | | Example G1 | Example G2 | Example G1 | Example G2 | Example G3 |
| Base Oil | mineral oil¹⁾ | 80 | 50 | 81 | 80 | 50 |
| | poly-α-olefin | — | 30 | — | — | 30 |
| | oil²⁾ | | | | | |

| | | | | | |
|---|---|---|---|---|---|
| Thickener: aromatic diurea | 18 | 18 | 18 | 18 | 18 |
| (mas. %)³⁾ | | | | | |
| Antioxidant⁴⁾ | 1 | 1 | 1 | 1 | 1 |
| Amine-type Rust Inhibitor⁵⁾ | 1 | 1 | — | — | — |
| Barium Sulfonate⁶⁾ | — | — | — | 1 | 1 |
| Flaking Probability after Bearing | 0 | 0 | 50 | 100 | 100 |
| Waterproofness Test (%) | | | | | |
| Rusting Rank⁷⁾ | A | A | C | A | A |
| Mixture Consistency | 278 | 275 | 283 | 280 | 277 |

Notes)
The unit is wt % except for the mixture consistency
¹⁾Mineral oil, having a kinematic viscosity at 40° C. of 98.3 mm²/sec
²⁾Poly-α-olefin oil, having a kinematic viscosity at 40° C. of 98.3 m²/sec
³⁾Diurea formed through reaction of 4,4′-diphenylmethane diisocyanate and p-toluidine
⁴⁾p,p′-dioctyldiphenylamine, by Tokyo Kasei
⁵⁾Amine-type rust inhibitor, containing a salt of oleic acid and dicyclohexylamine
⁶⁾Barium sulfonate, by Nihon Seika
⁷⁾Rusting Rank:
A: No rust.
B: From 1 to 5 rusty spots.
C: 6 or more rusty spots.

From Table 7, it is understood that the greases containing an amine-type rust inhibitor that contains a salt of oleic acid and dicyclohexylamine exhibit not only excellent flaking resistance but also excellent corrosion resistance. As opposed to these, the grease not containing the above amine-type rust inhibitor and the greases containing barium sulfonate as a rust inhibitor cold not exhibit sufficient flaking resistance and corrosion resistance.

### Example H

The above Embodiment 8 was tested, as described below.

### Examples H1 and H2

A mineral oil mixed with amine was reacted with a mineral oil mixed with diisocyanate, and stirred under heat to prepare an urea-type base grease. After gradually cooled, alkenylsuccinic acid anhydride was added to the base grease in an amount of 1 wt %, then stirred and defoamed to obtain a grease sample. In the same manner but using a mixed oil of a mineral oil and a poly-α-olefin oil as the base oil, another urea-type grease was produced.

### Comparative Examples H1 to H3

For comparison, a grease sample of the above urea-type base grease alone (Comparative Example H1); a grease sample containing 1 wt % of a rust inhibitor, barium sulfonate added to the urea-type base grease (Comparative Example H12); and a grease sample containing 1 wt % of a rust inhibitor, barium sulfonate added to an urea-type base grease containing a mixed oil of a mineral oil and a poly-α-olefin oil as the base oil thereof (Comparative Example H3) were prepared according to the above-mentioned method.

All grease samples were controlled to have a consistency of NLGI No. 2. They contained 1 wt % of an anine-type antioxidant (p,p′-dioctyldiphenylamine) added thereto.

### (Test for Rust Inhibition)

A grease sample is sealed up in ball bearing “608” of NSK to a level of 20% of the space volume, and left for one week in a constant temperature/humidity bath (test condition: temperature 80° C., humidity 90%), and the inner ring is visually checked for rusting. The tested samples are ranked as follows, based on the number of rusty spots.

A: No rust.

B: From 1 to 5 rusty spots.

C: 6 or more rusty spots.

### (Bearing Waterproofness Test)

A grease sample is sealed up in a tapered roller bearing by NSK (HR32017 (inner diameter 85 mm, outer diameter 130 mm)), and the bearing is continuously rotated under a radial load of 35.8 kN and an axial load of 15.7 kN and at a revolution of 1500 rpm with water being introduced into it from the outside at a rate of 20 ml/hr. The flaking test is continued for an intended period of 100 hours. At the time when the outer ring running surface of the bearing has flaked to give vibration, or after 100 hours with no flaking, the test is stopped. One grease sample is tested 10 times in the manner, and the flaking probability is obtained according to the following formula:

Flaking Probability (%)=(number of flaked samples/number of tested samples)×100.

TABLE 8

| | | | | Comparative | Comparative | Comparative |
|---|---|---|---|---|---|---|
| | | Example H1 | Example H2 | Example H1 | Example H2 | Example H3 |
| Base Oil | mineral oil¹⁾ | 80 | 50 | 81 | 80 | 50 |
| | poly-α-olefin | | 30 | — | — | 30 |
| | oil²⁾ | | | | | |

| | | | | | |
|---|---|---|---|---|---|
| Thickener: aromatic diurea³⁾ | 18 | 18 | 18 | 18 | 18 |
| Antioxidant⁴⁾ | 1 | 1 | 1 | 1 | 1 |
| Alkenylsuccinic Acid Anhydride⁵⁾ | 1 | 1 | — | — | — |
| Barium Sulfonate⁶⁾ | — | — | — | 1 | 1 |
| Flaking Probability after Bearing | 0 | 0 | 50 | 100 | 100 |
| Waterproofness Test (%) | | | | | |
| Rusting Rank⁷⁾ | A | A | C | A | A |
| Mixture Consistency | 280 | 276 | 283 | 280 | 277 |

Notes)
The unit is wt % except for the mixture consistency.
¹⁾Mineral oil, having a kinematic viscosity at 40° C. of 98.3 mm²/sec
²⁾Poly-α-olefin oil, having a kinematic viscosity at 40° C. of 98.7 mm²/sec
³⁾Diurea formed through reaction of 4,4′-diphenylmethane diisocyanate and p-toluidine
⁴⁾p,p′-dioctyldiphenylamine, by Tokyo Kasei
⁵⁾Alkenylsuccinic acid anhydride, in which the alkenyl group has 8 carbon atoms
⁶⁾Barium sulfonate, by Nihon Seika
⁷⁾Rusting Rank:
A: No rust.
B: From 1 to 5 rusty spots.
C: 6 or more rusty spots.

From Table 8, it is understood that the greases Containing alkenylsuccinic acid anhydride added thereto exhibit not only excellent flaking resistance but also excellent corrosion resistance. As opposed to these, the grease not containing alkenylsuccinic acid anhydride and the greases containing barium sulfonate as artist inhibitor could not exhibit sufficient flaking resistance and corrosion resistance.

Investigating the above-mentioned Examples and Comparative Examples A to H, it is believed that the absence of barium sulfonate is preferred in all the embodiments.

### INDUSTRIAL APPLICABILITY

The grease composition for hub unit bearings of the invention has excellent flaking resistance, waterproofness and corrosion resistance, and even when used in an environment in which water may penetrate into it or in a wet condition, the composition hardly causes white structure flaking and corrosion. Accordingly, the composition may keep good lubrication condition for a long period of time.

This application is based upon a Japanese patent application filed an Jan. 24, 2005 (Patent Application 2005-15496), a Japanese patent application filed on Jul. 12, 2005 (Patent Application 2005-203325), a Japanese patent application filed on Jul. 12, 2005 (Patent Application 2005-203329) and A Japanese patent application filed on Jul. 25, 2005 (Patent Application 2005-214053), and their contents are incorporated herein by reference.

1. A rolling bearing into which a grease composition comprising a waterproof film-forming additive is sealed up.

2. A grease composition for hub unit bearings, comprising:
a base oil that comprises at least one of mineral oil and synthetic oil as a main ingredient thereof;
a thickener; and
a flaking inhibitor.

3. The grease composition for hub unit bearings as set forth in claim 2, wherein
the thickener is at least one of metal soap, metal complex soap and urea compounds, and
the flaking inhibitor is a passivating agent, and the content of the passivating agent is from 0.1 to 5 wt %.

4. The grease composition for hub unit bearings as set forth in claim 2, wherein
the flaking inhibitor is oleoyl sarcosine, and its content is from 0.1 to 5 wt %.

5. The grease composition for hub unit bearings as set forth in claim 2, wherein
the flaking inhibitor is poly(oxyethylene)dodecylamine, and its content is from 0.1 to 3 wt %.

6. The grease composition for hub unit bearings as set forth in claim 2, wherein the flaking inhibitor is bismuth 2-ethylhexylate, and its content is from 0.1 to 5 wt %.

7. The grease composition for hub unit bearings as set forth in claim 2, wherein
the base oil is a mineral oil,
the thickener is an aromatic urea, and
the flaking inhibitor is calcium sulfonate, zinc dithiocarbamate, benzotriazole or its derivative.

8. The grease composition for hub unit bearings as set forth in claim 2, wherein
the thickener is a metal composite soap or an urea compound, and
the flaking inhibitor is a surfactant and a metal inactivator.

9. The grease composition for hub unit bearings as set forth in claim 2, wherein
the flaking inhibitor is an amine-type rust inhibitor comprising a salt of oleic acid and dicyclohexylamine, and its content is from 0.1 to 5 wt %.

10. The grease composition for hub unit bearings as set forth in claim 2, wherein the flaking inhibitor is a carboxylic acid anhydride, and its content is from 0.1 to 5 wt %.

11. A vehicular hub unit bearing, comprising
an outer diameter side member having a raceway surface in an inner peripheral surface thereof;
an inner diameter side member having a raceway surface in an outer peripheral surface thereof;
plural rolling elements rollably disposed between the raceway surface of the outer diameter side member and the raceway surface of the inner diameter side member; and
a cage rollably holding the plural rolling elements, wherein
the grease composition of any of claims 2 to 10 is sealed up in a space, which is formed between the inner diameter side member and the outer diameter side member and in which the rolling elements are disposed.
